(19) United States
(12) Patent Application Publication
(10) Pub. No.: US 2022/0073821 A1
(43) Pub. Date: Mar. 10, 2022

(54) STABILIZER COMPOSITION FOR SEALANTS AND ADHESIVES

(71) Applicant: BASF SE, Ludwigshafen am Rhein (DE)

(72) Inventors: Angelika ROSER, Ludwigshafen am Rhein (DE); Bernd HOEVEL, Ludwigshafen am Rhein (DE); Delphine KIMPEL, Ludwigshafen am Rhein (DE); Bernd HOCHSTEIN, Schweizerhalle (CH)

(21) Appl. No.: 17/422,858

(22) PCT Filed: Jan. 13, 2020
(86) PCT No.: PCT/EP2020/050654

§ 371 Date: Jul. 14, 2021

(30) Foreign Application Priority Data
Jan. 16, 2019 (EP) 19152099.8

(51) Int. Cl. C09K 15/30; C08G 65/336; C09K 3/10; C08K 5/3435; C08K 5/315

(52) U.S. Cl. CPC C09K 15/30; C08G 65/336; C09K 2200/0657; C08K 5/3435; C08K 5/315; C09K 3/10

(57) ABSTRACT

The present invention relates to a liquid stabilizer composition A containing (a) at least one liquid sterically hindered amine (HALS) in which the amino group carries a basicity-reducing substituent and which has a molecular weight of at most 1500 g/mol, preferably of at most 1000 g/mol; (b) at least one sterically hindered amine (HALS) having a molecular weight of more than 1500, preferably of at least 1700 g/mol; and (c) at least one liquid UV absorber. The invention relates also to a polymer composition which is in particular a sealant or adhesive composition, comprising at least one silyl-modified polymer and the stabilizer composition A. The invention relates moreover to the use of the stabilizer composition A in a sealant or adhesive composition. Such sealant or adhesive compositions show improved optical properties, also in the finished sealant or adhesive, such as increased clarity and/or reduced haze, and also an improved stability against degradation by heat, light and/or oxygen.

The present invention relates to a liquid stabilizer composition A containing (a) at least one liquid sterically hindered amine (HALS) in which the amino group carries a basicity-reducing substituent and which has a molecular weight of at most 1500 g/mol, preferably of at most 1000 g/mol; (b) at least one sterically hindered amine (HALS) having a molecular weight of more than 1500, preferably of at least 1700 g/mol; and (c) at least one liquid UV absorber. The invention relates also to a polymer composition, comprising at least one silyl-modified polymer and the stabilizer composition A. The invention relates moreover to the use of the stabilizer composition A in a sealant or adhesive composition. Such sealant or adhesive compositions show improved optical properties in the finished sealant or adhesive, such as increased clarity and/or reduced haze (turbidity), and also an improved stability. The invention also relates to the use of the stabilizer composition for stabilizing a silyl-modified polymer or a sealant, adhesive, gasket, knifing filler or coating composition, especially a sealant, adhesive, gasket, knifing filler or coating composition containing a silyl-modified polymer, or the finished products obtained from said compositions, against degradation by heat, light and/or oxygen, to the use of the polymer composition as or in a sealant, adhesive, liquid gasket, knifing filler or coating composition, and to a sealant composition or an adhesive composition, or a gasket composition, or a knifing filler composition or a coating composition comprising said polymer composition.

### TECHNICAL BACKGROUND

Sealants and adhesives based on synthetic polymeric materials like polyurethanes, polyureas, polyacrylates, silicones, polysulphides, etc. have found a very broad application field, e.g. in construction and civil engineering, in the automotive or aircraft industry, in watercraft construction, etc. Sealants are usually elastic materials that are employed to seal buildings or other structures against water, atmospheric influences, aggressive media, etc. Thus, in addition to blocking the passage of fluids, e.g. in water-proofing applications, sealants also serve for blocking dust, can provide thermal and acoustical insulation, may serve as fire barriers and can be used for simple smoothing or filling applications. In the sense of the present invention the term sealant also encompasses caulkings. Sealants and adhesives can be non-curable or curable materials. In many cases, after application the applied sealant undergoes an increase in viscosity to form the finished sealing material.

“Hybrid” sealants are based on polymers combining advantageous properties of two or more classes of different polymers. Thus, a polyether or polyurethane polymer or a polyether/polyurethane block-copolymer can be modified with silyl groups to yield a sealant having beneficial properties of polyethers/polyurethanes and silicones. Suitable polymers for hybrid sealants are e.g. silylated polyethers, silylated polyurethanes, silylated polyureas, silylated polysulphides and silylated acrylates.

Moisture-crosslinkable polymer compositions based on silyl-modified polymers (SMPs), such as silyl-terminated polymers (STPs) or polymers with lateral silyl groups, and their use in sealants, adhesives and coating compositions are known. In the presence of atmospheric moisture, SMPs with hydrolysable substituents, such as alkoxy groups, are capable of condensing with one another yet at room temperature; resulting thus in cured or crosslinked polymers. Depending on the content of silyl groups with hydrolysable substituents and the structure of these silyl groups, mainly long-chain polymers (thermoplastics), relatively wide-mesh, three-dimensional networks (elastomers) or highly crosslinked systems (thermosets) are formed during this process.

In the present invention, the terms “curing” and “crosslinking” are used interchangeably, referring to the hardening of a polymer material by cross-linking of polymer chains.

Sealing, adhesive and coating materials are used in a wide variety of applications and materials. If transparent materials, like glass, are part of the application, light, especially UV radiation, reaches the sealing, adhesive or coating material, which makes it prone to deterioration if it is not stabilized appropriately. Non-transparent applications or applications not exposed to light may also be prone to deterioration, for example if exposed to heat, like in flooring close to heat sources, or to deterioration caused by atmospheric oxygen.

Demands relating to the long-term UV resistance of sealants, adhesives and coating compositions are becoming ever higher. The same holds true for temperature resistance and resistance against oxidation. A challenge is also the demand for crystal clear sealants, adhesives and coating composition which show no haze, neither shortly after application nor over time. Thus, there is a continuing need for temperature- and/or UV- and/or oxidation-resistant compositions which are suitable for use as a sealant, adhesive and/or coating composition and which additionally have beneficial and indispensable properties that are required in the area of this type of application, one example being optical properties, such as high clarity and the absence of haze at least for certain application, such as in sealants for glass substrates.

High-molecular weight light stabilizer, such as HALS having a molecular weight of more than 1500 g/mol, have a longer lasting stabilizing effect than lower molecular weight light stabilizers since they are more persistent and less prone to washing out. On the other side, they are more difficult to be incorporated into liquid compositions since their solubility is rather poor, at least in solvents acceptable for sealants or adhesives.

Sealants and adhesives are generally formulated with a combination of additives, e.g. for the stabilization against degradation by light, oxygen and/or heat.

Phenolic compounds are very efficient antioxidants. Their effect is generally not limited to the protection against oxidation caused by (UV) light, but also by heat. Thus, they are particularly suitable for outside applications. Unfortunately, however, phenolic antioxidants, especially liquid ones, tend to “pinking”, i.e. the applied composition colors over time. On the other side, it is very desirable to combine the efficient antioxidant properties of phenolic compounds and the similarly efficient light-stabilizing properties of sterically hindered amines.

WO 2016/184932 relates to a stabilized hot melt adhesive containing a hot melt adhesive material and two or three of the following components: (A) a specific monomeric sterically hindered amine; (B) a specific polymeric sterically hindered amine; (C) a specific sterically hindered phenol.

WO 2012/010570 describes an additive dispersion for adhesive or sealants applications comprising at least two sterically hindered amines, at least one further stabilizer selected from a UV absorber such as Tinuvin® 312 and a light stabilizer such as Tinuvin® 120, a dispersing agent and a plasticizer. The reference lists as suitable sterically hindered amines non-discriminatingly low and high-molecular compounds as well as compounds carrying on the nitrogen atom of the piperidine ring both electron-withdrawing groups (NOR HALS) or electron-donating alkyl groups (NR HALS). The additive composition may be used inter alia for stabilizing silyl-modified polyethers, polyesters, polyacrylates or polyurethanes.

For visible and in particular for transparent applications the market demands sealants and adhesives resulting in finished compositions that are substantially clear and/or show substantially no haze. Furthermore, sealants and adhesives are intended to have very good processing properties, such as being applicable without substantial exertion of force. In this context, it is advantageous if the stabilizer system employed for the formulation of the sealants and adhesives is in liquid form without the use of extraneous solvents. It is also desirable to provide an additive combination which is stable without the presence of dispersants, surfactants, emulsifiers and the like.

The object of the present invention was thus to provide a liquid stabilizer composition suitable for sealants or adhesives, especially for sealants or adhesives based on silyl-modified polymers (SMPs), which effectively stabilizes the sealant or adhesive equipped therewith (both the sealant or adhesive composition before application and, more importantly, the finished sealant or adhesive after application) against light and optionally also against heat and/or oxygen. The stabilizer composition should be liquid without having to resort to solvents, should be stable without the presence of dispersants, surfactants, emulsifiers and the like, should be combinable with phenolic antioxidants without causing any “pinking” of the substrate equipped therewith over time, and/or should be substantially clear and/or show substantially no haze.

Surprisingly it was found that the above-described objects can be achieved if a liquid low-molecular weight HALS carrying a basicity-reducing substituent on the nitrogen atom of the piperidine ring (of each piperidine ring if more than one is present) is combined with a high-molecular weight HALS and a liquid UV absorber. The liquid low-molecular weight HALS serves as a solvent for the other components, so that the presence of an additional solvent can be dispensed with. The presence of any surface active compounds, such as dispersants, surfactants, emulsifiers and the like, is not necessary, either.

### SUMMARY OF THE INVENTION

In one aspect, the invention thus relates to a liquid stabilizer composition, measured according to DIN EN ISO 3219, comprising:
(a) at least one liquid light stabilizer, measured according to DIN EN ISO 3219, selected from sterically hindered amines (HALS) in which the amino group carries a basicity-reducing substituent, the liquid light stabilizer having a molecular weight of at most 1500 g/mol and have a pK_{b} value of from 7 to 10;
(b) at least one light stabilizer, measured according to DIN EN ISO 3219, selected from sterically hindered amines (HALS) having a molecular weight of more than 1500 and have a pK_{b} value of from 7 to 10;
(c) at least one liquid UV absorber, measured according to DIN EN ISO 3219;
(d) optionally at least one antioxidant; and
(e) optionally at least one further additive;
   wherein the basicity-reducing substituent is selected from the group consisting alkoxy, alkenyloxy, alkynyloxy, cycloalkoxy, phenyloxy or benzyloxy groups and carbonyl or thiocarbonyl groups either bound directly or flexibly in γ- or δ-position to the nitrogen ring atom.

This liquid stabilizer composition is termed in the following as composition A.

In another aspect, the invention relates to a polymer composition (sealant or adhesive composition) comprising
(i) at least one silyl-modified polymer, in particular at least one silyl-terminated polymer; and
(ii) a stabilizer composition A as defined above.

In other words, the polymer composition comprises
(i) at least one silyl-modified polymer, in particular at least one silyl-terminated polymer;
(ii) at least one liquid light stabilizer, measured according to DIN EN ISO 3219, selected from sterically hindered amines (HALS) in which the amino group carries a basicity-reducing substituent, the liquid light stabilizer having a molecular weight of at most 1500 g/mol and have a pK_{b} value of from 7 to 10; at least one light stabilizer, measured according to DIN EN ISO 3219, selected from sterically hindered amines (HALS) having a molecular weight of more than 1500 and have a pK_{b} value of from 7 to 10;
   at least one liquid UV absorber, measured according to DIN EN ISO 3219;
   optionally at least one antioxidant; and
   optionally at least one further additive
      wherein the basicity-reducing substituent is selected from the group consisting alkoxy, alkenyloxy, alkynyloxy, cycloalkoxy, phenyloxy or benzyloxy groups and carbonyl or thiocarbonyl groups either bound directly or flexibly in γ- or δ-position to the nitrogen ring atom.

This polymer composition is termed in the following as composition B.

The invention further relates to the use of the stabilizer composition A of the invention for stabilizing a silyl-modified polymer, in particular a silyl-terminated polymer, or a sealant, adhesive, gasket, knifing filler or coating composition, especially a sealant, adhesive, gasket, knifing filler or coating composition containing a silyl-modified polymer, in particular a silyl-terminated polymer, or the finished products obtained from said polymer or compositions, against degradation by light, heat and/or oxygen, to the use of the polymer composition B of the invention as or in a sealant, adhesive, gasket, knifing filler or coating composition, to a sealant composition or an adhesive composition, or a gasket composition, or a knifing filler composition or a coating composition comprising the polymer composition B of the invention and to a method for stabilizing a silyl-modified polymer, in particular a silyl-terminated polymer, or a sealant, adhesive, gasket, knifing filler or coating composition, especially a sealant, adhesive, liquid gasket, knifing filler or coating composition containing a silyl-modified polymer, in particular a silyl-terminated polymer, or the finished products obtained from said compositions, against degradation by light, heat and/or oxygen.

The invention also relates to the use of the stabilizer composition A in a sealant or adhesive composition, in particular in a sealant or adhesive composition comprising a silyl-modified polymer, for improving at least one optical property in the finished sealant or adhesive, where the improved optical property is selected from increased clarity and/or reduced haze.

### DETAILED DESCRIPTION OF THE INVENTION

The organic moieties mentioned in the below definitions of the variables are collective terms for individual listings of the individual group members. The prefix Cₙ-Cₘ indicates in each case the possible number of carbon atoms in the group.

The term “alkyl” as used herein and in the alkyl moieties of alkoxy, alkylcarbonyl and the like refers to saturated straight-chain or branched hydrocarbon radicals having 1 to 2 (“C₁-C₂-alkyl”), 1 to 3 (“C₁-C₃-alkyl”), 1 to 4 (“C₁-C₄-alkyl”), 1 to 6 (“C₁-C₆-alkyl”), 1 to 8 (“C₁-C₈-alkyl”), 1 to 10 (“C₁-C₁₂-alkyl”), 1 to 12 (“C₁-C₁₂-alkyl”), 4 to 12 (“C₄-C₁₂-alkyl”), 12 or 13 (“C₁₂-C₁₃-alkyl”), 1 to 14 (“C₁-C₁₄-alkyl”), or 4 to 20 (“C₄-C₂₀-alkyl”) carbon atoms. C₁-C₂-Alkyl is methyl or ethyl. Examples for C₁-C₃-alkyl are, in addition to those mentioned for C₁-C₂-alkyl, n-propyl and isopropyl. Examples for C₁-C₄-alkyl are, in addition to those mentioned for C₁-C₃-alkyl, n-butyl, 1-methylpropyl (sec-butyl), 2-methylpropyl (isobutyl) or 1,1-dimethylethyl (tert-butyl). Examples for C₁-C₆-alkyl are, in addition to those mentioned for C₁-C₄-alkyl, n-pentyl, 1-methylbutyl, 2-methylbutyl, 3-methylbutyl, 2,2-dimethylpropyl, 1-ethylpropyl, 1,1-dimethylpropyl, 1,2-dimethylpropyl, n-hexyl, 1-methylpentyl, 2-methylpentyl, 3-methylpentyl, 4-methylpentyl, 1,1-dimethylbutyl, 1,2-dimethylbutyl, 1,3-dimethylbutyl, 2,2-dimethylbutyl, 2,3-dimethylbutyl, 3,3-dimethylbutyl, 1-ethylbutyl, 2-ethylbutyl, 1,1,2-trimethylpropyl, 1,2,2-trimethylpropyl, 1-ethyl-1-methylpropyl, or 1-ethyl-2-methylpropyl. Examples for C₁-C₈-alkyl are, in addition to those mentioned for C₁-C₆-alkyl, n-heptyl, n-octyl, 2-ethylhexyl and positional isomers thereof. Examples for C₁-C₁₀-alkyl are, in addition to those mentioned for C₁-C₈-alkyl, n-nonyl, n-decyl and positional isomers thereof. Examples for C₁-C₁₂-alkyl are, in addition to those mentioned for C₁-C₁₀-alkyl, n-undecyl, n-dodecyl, and positional isomers thereof. Examples for C₁-C₁₄-alkyl are, in addition to those mentioned for C₁-C₁₂-alkyl, n-tridecyl, n-tetradecyl, and positional isomers thereof. C₄-C₁₂-Alkyl is for example n-butyl, 1-methylpropyl (sec-butyl), 2-methylpropyl (isobutyl), 1,1-dimethylethyl (tert-butyl), n-pentyl, 1-methylbutyl, 2-methylbutyl, 3-methylbutyl, 2,2-dimethylpropyl, 1-ethylpropyl, 1,1-dimethylpropyl, 1,2-dimethylpropyl, n-hexyl, 1-methylpentyl, 2-methylpentyl, 3-methylpentyl, 4-methylpentyl, 1,1-dimethylbutyl, 1,2-dimethylbutyl, 1,3-dimethylbutyl, 2,2-dimethylbutyl, 2,3-dimethylbutyl, 3,3-dimethylbutyl, 1-ethylbutyl, 2-ethylbutyl, 1,1,2-trimethylpropyl, 1,2,2-trimethylpropyl, 1-ethyl-1-methylpropyl, 1-ethyl-2-methylpropyl, n-heptyl, n-octyl, 2-ethylhexyl, n-nonyl, n-decyl, n-undecyl, n-dodecyl, and positional isomers thereof. Examples for C₄-C₂₀-alkyl are, in addition to those mentioned for C₄-C₁₂-alkyl, n-tridecyl, n-tetradecyl, n-pentadecyl, n-hexadecyl, n-heptadecyl, n-octadecyl, n-nonadecyl, n-eicosyl and positional isomers thereof. Examples for C₁-C₂₀-alkyl are, in addition to those mentioned for C₁-C₁₂-alkyl, n-tridecyl, n-tetradecyl, n-pentadecyl, n-hexadecyl, n-heptadecyl, n-octadecyl, n-nonadecyl, n-eicosyl and positional isomers thereof. Examples for C₁₂-C₁₃-alkyl are n-dodecyl, n-tridecyl and positional isomers thereof.

The term “hydroxyalkyl” denotes an alkyl group, as mentioned above, in which one hydrogen atom is replaced by a hydroxyl group. C₂-C₄-hydroxyalkyl is a C₂-C₄-alkyl group in which one hydrogen atom is replaced by a hydroxyl group. Examples are 1-hydroxyethyl, 2-hydroxyethyl, 1-hydroxypropyl, 2-hydroxypropyl, 3-hydroxypropyl, 1-hydroxy-1-methylethyl, 2-hydroxy-1-methylethyl, 1-hydroxybutyl, 2-hydroxybutyl, 3-hydroxybutyl, 4-hydroxybutyl, 1-hydroxy-1-methylpropyl, 2-hydroxy-1-methylpropyl, 3-hydroxy-1-methylpropyl, 1-(hydroxymethyl)-propyl, 1-hydroxy-2-methylpropyl, 2-hydroxy-2-methylpropyl, 3-hydroxy-2-methylpropyl, 2-(hydroxymethyl)-propyl, and 1-(hydroxymethyl)-2-methyl-ethyl. Among these, preference is given to radicals in which the hydroxyl group is not bound to the attachment point of hydroxyalkyl to the remainder of the molecule, especially if the hydroxyalkyl group is bound to an oxygen or a nitrogen atom. Thus, preferred examples of C₂-C₄-hydroxyalkyl are 2-hydroxyethyl, 2-hydroxypropyl, 3-hydroxypropyl, 2-hydroxy-1-methylethyl, 2-hydroxybutyl, 3-hydroxybutyl, 4-hydroxybutyl, 2-hydroxy-1-methylpropyl, 3-hydroxy-1-methylpropyl, 1-(hydroxymethyl)-propyl, 2-hydroxy-2-methylpropyl, 3-hydroxy-2-methylpropyl, 2-(hydroxymethyl)-propyl, and 1-(hydroxymethyl)-2-methyl-ethyl.

If the term “alkenyl” as used herein and in the alkyl moieties of alkenyloxy is used without prefix (Cₙ-Cₘ), it indicates monounsaturated (i.e. containing one C—C double bond) straight-chain or branched aliphatic hydrocarbon radicals having in general 2 to 20 (“C₂-C₂₀-alkenyl”) carbon atoms, in particular 2 to 10 (“C₂-C₁₀-alkenyl”) carbon atoms, specifically 2 to 6 (“C₂-C₆-alkenyl”) or 2 to 4 (“C₂-C₄-alkenyl”) carbon atoms, where the C—C double bond can be in any position. “C₂-C₃-alkenyl” refers to monounsaturated straight-chain or branched aliphatic hydrocarbon radicals having 2 to 3 carbon atoms and a C—C double bond in any position. “C₂-C₄-alkenyl” refers to monounsaturated straight-chain or branched aliphatic hydrocarbon radicals having 2 to 4 carbon atoms and a C—C double bond in any position. “C₂-C₆-alkenyl” refers to monounsaturated straight-chain or branched aliphatic hydrocarbon radicals having 2 to 6 carbon atoms and a C—C double bond in any position. “C₂-C₈-alkenyl” refers to monounsaturated straight-chain or branched aliphatic hydrocarbon radicals having 2 to 8 carbon atoms and a C—C double bond in any position. “C₂-C₁₀-alkenyl” refers to monounsaturated straight-chain or branched aliphatic hydrocarbon radicals having 2 to 10 carbon atoms and a C—C double bond in any position. “C₂-C₂₀-alkenyl” refers to monounsaturated straight-chain or branched aliphatic hydrocarbon radicals having 2 to 20 carbon atoms and a C—C double bond in any position. Examples for C₂-C₃-alkenyl are ethenyl, 1-propenyl, 2-propenyl or 1-methylethenyl. Examples for C₂-C₄-alkenyl are ethenyl, 1-propenyl, 2-propenyl, 1-methylethenyl, 1-butenyl, 2-butenyl, 3-butenyl, 1-methyl-1-propenyl, 2-methyl-1-propenyl, 1-methyl-2-propenyl or 2-methyl-2-propenyl. Examples for C₂-C₆-alkenyl are ethenyl, 1-propenyl, 2-propenyl, 1-methylethenyl, 1-butenyl, 2-butenyl, 3-butenyl, 1-methyl-1-propenyl, 2-methyl-1-propenyl, 1-methyl-2-propenyl, 2-methyl-2-propenyl, 1-pentenyl, 2-pentenyl, 3-pentenyl, 4-pentenyl, 1-methyl-1-butenyl, 2-methyl-1-butenyl, 3-methyl-1-butenyl, 1-methyl-2-butenyl, 2-methyl-2-butenyl, 3-methyl-2-butenyl, 1-methyl-3-butenyl, 2-methyl-3-butenyl, 3-methyl-3-butenyl, 1,1-dimethyl-2-propenyl, 1,2-dimethyl-1-propenyl, 1,2-dimethyl-2-propenyl, 1-ethyl-1-propenyl, 1-ethyl-2-propenyl, 1-hexenyl, 2-hexenyl, 3-hexenyl, 4-hexenyl, 5-hexenyl, 1-methyl-1-pentenyl, 2-methyl-1-pentenyl, 3-methyl-1-pentenyl, 4-methyl-1-pentenyl, 1-methyl-2-pentenyl, 2-methyl-2-pentenyl, 3-methyl-2-pentenyl, 4-methyl-2-pentenyl, 1-methyl-3-pentenyl, 2-methyl-3-pentenyl, 3-methyl-3-pentenyl, 4-methyl-3-pentenyl, 1-methyl-4-pentenyl, 2-methyl-4-pentenyl, 3-methyl-4-pentenyl, 4-methyl-4-pentenyl, 1,1-dimethyl-2-butenyl, 1,1-dimethyl-3-butenyl, 1,2-dimethyl-1-butenyl, 1,2-dimethyl-2-butenyl, 1,2-dimethyl-3-butenyl, 1,3-dimethyl-1-butenyl, 1,3-dimethyl-2-butenyl, 1,3-dimethyl-3-butenyl, 2,2-dimethyl-3-butenyl, 2,3-dimethyl-1-butenyl, 2,3-dimethyl-2-butenyl, 2,3-dimethyl-3-butenyl, 3,3-dimethyl-1-butenyl, 3,3-dimethyl-2-butenyl, 1-ethyl-1-butenyl, 1-ethyl-2-butenyl, 1-ethyl-3-butenyl, 2-ethyl-1-butenyl, 2-ethyl-2-butenyl, 2-ethyl-3-butenyl, 1,1,2-trimethyl-2-propenyl, 1-ethyl-1-methyl-2-propenyl, 1-ethyl-2-methyl-1-propenyl, 1-ethyl-2-methyl-2-propenyl and the like. Examples for C₂-C₁₀-alkenyl are, in addition to the examples mentioned for C₂-C₆-alkenyl, 1-heptenyl, 2-heptenyl, 3-heptenyl, 1-octenyl, 2-octenyl, 3-octenyl, 4-octenyl, 1-nonenyl, 2-nonenyl, 3-nonenyl, 4-nonenyl, 1-decenyl, 2-decenyl, 3-decenyl, 4-decenyl, 5-decenyl and the positional isomers thereof.

If the term “alkynyl” as used herein and in the alkynyl moieties of alkynyloxy is used without prefix (Cₙ-Cₘ), it indicates straight-chain or branched aliphatic hydrocarbon radicals having in general 2 to 20 (“C₂-C₂₀-alkynyl”) carbon atoms, in particular 2 to 10 (“C₂-C₁₀-alkynyl”) carbon atoms, specifically 2 to 6 (“C₂-C₆-alkynyl”) or 2 to 4 (“C₂-C₄-alkynyl”) carbon atoms, and one triple bond in any position. “C₂-C₃-Alkynyl” indicates straight-chain or branched hydrocarbon radicals having 2 to 3 carbon atoms and one triple bond in any position. “C₂-C₄-Alkynyl” indicates straight-chain or branched hydrocarbon radicals having 2 to 4 carbon atoms and one triple bond in any position. “C₂-C₆-Alkynyl” indicates straight-chain or branched hydrocarbon radicals having 2 to 6 carbon atoms and one triple bond in any position. “C₂-C₈-Alkynyl” indicates straight-chain or branched hydrocarbon radicals having 2 to 8 carbon atoms and one triple bond in any position. “C₂-C₁₀-Alkynyl” indicates straight-chain or branched hydrocarbon radicals having 2 to 10 carbon atoms and one triple bond in any position. “C₂-C₂₀-Alkynyl” indicates straight-chain or branched hydrocarbon radicals having 2 to 20 carbon atoms and one triple bond in any position. Examples for C₂-C₃-alkynyl are ethynyl, 1-propynyl or 2-propynyl. Examples for C₂-C₄-alkynyl are ethynyl, 1-propynyl, 2-propynyl, 1-butynyl, 2-butynyl, 3-butynyl, 1-methyl-2-propynyl and the like. Examples for C₂-C₆-alkynyl are ethynyl, 1-propynyl, 2-propynyl, 1-butynyl, 2-butynyl, 3-butynyl, 1-methyl-2-propynyl, 1-pentynyl, 2-pentynyl, 3-pentynyl, 4-pentynyl, 1-methyl-2-butynyl, 1-methyl-3-butynyl, 2-methyl-3-butynyl, 3-methyl-1-butynyl, 1,1-dimethyl-2-propynyl, 1-ethyl-2-propynyl, 1-hexynyl, 2-hexynyl, 3-hexynyl, 4-hexynyl, 5-hexynyl, 1-methyl-2-pentynyl, 1-methyl-3-pentynyl, 1-methyl-4-pentynyl, 2-methyl-3-pentynyl, 2-methyl-4-pentynyl, 3-methyl-1-pentynyl, 3-methyl-4-pentynyl, 4-methyl-1-pentynyl, 4-methyl-2-pentynyl, 1,1-dimethyl-2-butynyl, 1,1-dimethyl-3-butynyl, 1,2-dimethyl-3-butynyl, 2,2-dimethyl-3-butynyl, 3,3-dimethyl-1-butynyl, 1-ethyl-2-butynyl, 1-ethyl-3-butynyl, 2-ethyl-3-butynyl, 1-ethyl-1-methyl-2-propynyl and the like.

The term “cycloalkyl” as used herein refers to monocyclic saturated hydrocarbon radicals having 3 to 6 carbon atoms (“C₃-C₆-cycloalkyl”). Examples of C₃-C₆-cycloalkyl are cyclopropyl, cyclobutyl, cyclopentyl and cyclohexyl.

The term “alkoxy” refers to alkyl group, as defined above, attached via an oxygen atom to the remainder of the molecule. If the term “alkoxy” is used without prefix (Cₙ-Cₘ), it relates to C₁-C₂₀-alkoxy. “C₁-C₂-Alkoxy” is a C₁-C₂-alkyl group, as defined above, attached via an oxygen atom to the remainder of the molecule. “C₁-C₃-Alkoxy” is a C₁-C₃-alkyl group, as defined above, attached via an oxygen atom to the remainder of the molecule. “C₁-C₄-Alkoxy” is a C₁-C₄-alkyl group, as defined above, attached via an oxygen atom to the remainder of the molecule. “C₁-C₆-Alkoxy” is a C₁-C₆-alkyl group, as defined above, attached via an oxygen atom to the remainder of the molecule. “C₁-C₁₂-Alkoxy” is a C₁-C₁₂-alkyl group, as defined above, attached via an oxygen atom to the remainder of the molecule. “C₁-C₂₀-Alkoxy” is a C₁-C₂₀-alkyl group attached via an oxygen atom to the remainder of the molecule. “C₁₂-C₁₄-Alkoxy” is a C₁₂-C₁₄-alkyl group, as defined above, attached via an oxygen atom to the remainder of the molecule. C₁-C₂-Alkoxy is methoxy or ethoxy. Examples for C₁-C₃-alkoxy are, in addition to those mentioned for C₁-C₂-alkoxy, n-propoxy and 1-methylethoxy (isopropoxy). Examples for C₁-C₄-alkoxy are, in addition to those mentioned for C₁-C₃-alkoxy, butoxy, 1-methylpropoxy (sec-butoxy), 2-methylpropoxy (isobutoxy) or 1,1-dimethylethoxy (tert-butoxy). Examples for C₁-C₆-alkoxy are, in addition to those mentioned for C₁-C₄-alkoxy, pentoxy, 1-methylbutoxy, 2-methylbutoxy, 3-methylbutoxy, 1,1-dimethylpropoxy, 1,2-dimethylpropoxy, 2,2-dimethylpropoxy, 1-ethylpropoxy, hexoxy, 1-methylpentoxy, 2-methylpentoxy, 3-methylpentoxy, 4-methylpentoxy, 1,1-dimethylbutoxy, 1,2-dimethylbutoxy, 1,3-dimethylbutoxy, 2,2-dimethylbutoxy, 2,3-dimethylbutoxy, 3,3-dimethylbutoxy, 1-ethylbutoxy, 2-ethylbutoxy, 1,1,2-trimethylpropoxy, 1,2,2-trimethylpropoxy, 1-ethyl-1-methylpropoxy or 1-ethyl-2-methylpropoxy. Examples for C₁-C₁₂-alkoxy are, in addition to those mentioned for C₁-C₆-alkoxy, heptyloxy, octyloxy, 2-ethylhexyloxy, nonyloxy, decyloxy, undecyloxy, dodecyloxy, and positional isomers thereof. Examples for C₁-C₂₀-alkoxy are, in addition to those mentioned for C₁-C₁₂-alkoxy, tridecyloxy, tetradecyloxy, pentadecyloxy, hexadecyloxy, heptadecyloxy, octadecyloxy, nonadecyloxy, eicosanyloxy, and positional isomers thereof. Examples for C₁₂-C₁₄-alkoxy are dodecyloxy, tridecyloxy, tetradecyloxy, and positional isomers thereof.

The term “alkenyloxy” refers to an alkenyl group, as defined above, attached via an oxygen atom to the remainder of the molecule. If the term “alkenyloxy” is used without prefix (Cₙ-Cₘ), it relates to C₂-C₂₀-alkenyloxy. Examples for C₂-C₃-alkenyloxy are ethenyloxy, 1-propenyloxy, 2-propenyloxy or 1-methylethenyloxy. Examples for C₂-C₄-alkenyloxy are ethenyloxy, 1-propenyloxy, 2-propenyloxy, 1-methylethenyloxy, 1-butenyloxy, 2-butenyloxy, 3-butenyloxy, 1-methyl-1-propenyloxy, 2-methyl-1-propenyloxy, 1-methyl-2-propenyloxy or 2-methyl-2-propenyloxy. Examples for C₂-C₆-alkenyloxy are, in addition to those mentioned for C₂-C₆-alkenyloxy, 1-pentenyloxy, 2-pentenyloxy, 3-pentenyloxy, 4-pentenyloxy, 1-methyl-1-butenyloxy, 2-methyl-1-butenyloxy, 3-methyl-1-butenyloxy, 1-methyl-2-butenyloxy, 2-methyl-2-butenyloxy, 3-methyl-2-butenyloxy, 1-methyl-3-butenyloxy, 2-methyl-3-butenyloxy, 3-methyl-3-butenyloxy, 1,1-dimethyl-2-propenyloxy, 1,2-dimethyl-1-propenyloxy, 1,2-dimethyl-2-propenyloxy, 1-ethyl-1-propenyloxy, 1-ethyl-2-propenyloxy, 1-hexenyloxy, 2-hexenyloxy, 3-hexenyloxy, 4-hexenyloxy, 5-hexenyloxy, 1-methyl-1-pentenyloxy, 2-methyl-1-pentenyloxy, 3-methyl-1-pentenyloxy, 4-methyl-1-pentenyloxy, 1-methyl-2-pentenyloxy, 2-methyl-2-pentenyloxy, 3-methyl-2-pentenyloxy, 4-methyl-2-pentenyloxy, 1-methyl-3-pentenyloxy, 2-methyl-3-pentenyloxy, 3-methyl-3-pentenyloxy, 4-methyl-3-pentenyloxy, 1-methyl-4-pentenyloxy, 2-methyl-4-pentenyloxy, 3-methyl-4-pentenyloxy, 4-methyl-4-pentenyloxy, 1,1-dimethyl-2-butenyloxy, 1,1-dimethyl-3-butenyloxy, 1,2-dimethyl-1-butenyloxy, 1,2-dimethyl-2-butenyloxy, 1,2-dimethyl-3-butenyloxy, 1,3-dimethyl-1-butenyloxy, 1,3-dimethyl-2-butenyloxy, 1,3-dimethyl-3-butenyloxy, 2,2-dimethyl-3-butenyloxy, 2,3-dimethyl-1-butenyloxy, 2,3-dimethyl-2-butenyloxy, 2,3-dimethyl-3-butenyloxy, 3,3-dimethyl-1-butenyloxy, 3,3-dimethyl-2-butenyloxy, 1-ethyl-1-butenyloxy, 1-ethyl-2-butenyloxy, 1-ethyl-3-butenyloxy, 2-ethyl-1-butenyloxy, 2-ethyl-2-butenyloxy, 2-ethyl-3-butenyloxy, 1,1,2-trimethyl-2-propenyloxy, 1-ethyl-1-methyl-2-propenyloxy, 1-ethyl-2-methyl-1-propenyloxy, 1-ethyl-2-methyl-2-propenyloxy and the like. Examples for C₂-C₁₀-alkenyloxy are, in addition to the examples mentioned for C₂-C₆-alkenyloxy, 1-heptenyloxy, 2-heptenyloxy, 3-heptenyloxy, 1-octenyloxy, 2-octenyloxy, 3-octenyloxy, 4-octenyloxy, 1-nonenyloxy, 2-nonenyloxy, 3-nonenyloxy, 4-nonenyloxy, 1-decenyloxy, 2-decenyloxy, 3-decenyloxy, 4-decenyloxy, 5-decenyloxy and the positional isomers thereof.

The term “alkynyloxy” refers to an alkynyl group, as defined above, attached via an oxygen atom to the remainder of the molecule. If the term “alkynyloxy” is used without prefix (Cₙ-Cₘ), it relates to C₂-C₂₀-alkynyloxy. Examples for C₂-C₃-alkynyloxy are ethynyloxy, 1-propynyloxy or 2-propynyloxy. Examples for C₂-C₄-alkynyl are ethynyloxy, 1-propynyloxy, 2-propynyloxy, 1-butynyloxyoxy, 2-butynyl, 3-butynyloxy, 1-methyl-2-propynyloxy and the like. Examples for C₂-C₆-alkynyloxy are, in addition to those mentioned for C₂-C₆-alkenyloxy, 1-pentynyloxy, 2-pentynyloxy, 3-pentynyloxy, 4-pentynyloxy, 1-methyl-2-butynyloxy, 1-methyl-3-butynyloxy, 2-methyl-3-butynyloxy, 3-methyl-1-butynyloxy, 1,1-dimethyl-2-propynyloxy, 1-ethyl-2-propynyloxy, 1-hexynyloxy, 2-hexynyloxy, 3-hexynyloxy, 4-hexynyloxy, 5-hexynyloxy, 1-methyl-2-pentynyloxy, 1-methyl-3-pentynyloxy, 1-methyl-4-pentynyloxy, 2-methyl-3-pentynyloxy, 2-methyl-4-pentynyloxy, 3-methyl-1-pentynyloxy, 3-methyl-4-pentynyloxy, 4-methyl-1-pentynyloxy, 4-methyl-2-pentynyloxy, 1,1-dimethyl-2-butynyloxy, 1,1-dimethyl-3-butynyloxy, 1,2-dimethyl-3-butynyloxy, 2,2-dimethyl-3-butynyloxy, 3,3-dimethyl-1-butynyloxy, 1-ethyl-2-butynyloxy, 1-ethyl-3-butynyloxy, 2-ethyl-3-butynyloxy, 1-ethyl-1-methyl-2-propynyloxy and the like.

The term “cycloalkoxy” refers to a cycloalkyl group, as defined above, attached via an oxygen atom to the remainder of the molecule. If the term “cycloalkoxy” is used without prefix (Cₙ-Cₘ), it relates to C₃-C₆-cycloalkoxy. Examples of C₃-C₆-cycloalkoxy are cyclopropoxy, cyclobutoxy, cyclopentoxy and cyclohexoxy.

The term “alkylthio” refers to alkyl group, as defined above, attached via a sulfur atom to the remainder of the molecule. “C₁-C₂-Alkylthio” is a C₁-C₂-alkyl group, as defined above, attached via a sulfur atom to the remainder of the molecule. “C₁-C₃-Alkylthio” is a C₁-C₃-alkyl group, as defined above, attached via a sulfur atom to the remainder of the molecule. “C₁-C₄-Alkylthio” is a C₁-C₄-alkyl group, as defined above, attached via a sulfur atom to the remainder of the molecule. “C₁-C₆-Alkylthio” is a C₁-C₆-alkyl group, as defined above, attached via a sulfur atom to the remainder of the molecule. C₁-C₂-Alkylthio is methylthio or ethylthio. Examples for C₁-C₃-alkylthio are, in addition to those mentioned for C₁-C₂-alkylthio, n-propylthio and 1-methylethylthio (isopropylthio). Examples for C₁-C₄-alkylthio are, in addition to those mentioned for C₁-C₃-alkylthio, butylthio, 1-methylpropylthio (sec-butylthio), 2-methylpropylthio (isobutylthio) or 1,1-dimethylethylthio (tert-butylthio). Examples for C₁-C₆-alkylthio are, in addition to those mentioned for C₁-C₄-alkylthio, pentylthio, 1-methylbutylthio, 2-methylbutylthio, 3-methylbutylthio, 1,1-dimethylpropylthio, 1,2-dimethylpropylthio, 2,2-dimethylpropylthio, 1-ethylpropylthio, hexylthio, 1-methylpentylthio, 2-methylpentylthio, 3-methylpentylthio, 4-methylpentylthio, 1,1-dimethylbutylthio, 1,2-dimethyl butylthio, 1,3-dimethylbutylthio, 2,2-dimethylbutylthio, 2,3-dimethylbutylthio, 3,3-dimethylbutylthio, 1-ethylbutylthio, 2-ethylbutylthio, 1,1,2-trimethylpropylthio, 1,2,2-trimethylpropylthio, 1-ethyl-1-methylpropylthio or 1-ethyl-2-methylpropylthio.

The term “alkylsulfinyl” refers to alkyl group, as defined above, attached via a sulfinyl group [S(═O)] to the remainder of the molecule. “C₁-C₂-Alkylsulfinyl” is a C₁-C₂-alkyl group, as defined above, attached via a sulfinyl group to the remainder of the molecule. “C₁-C₃-Alkylsulfinyl” is a C₁-C₃-alkyl group, as defined above, attached via a sulfinyl group to the remainder of the molecule. “C₁-C₄-Alkylsulfinyl” is a C₁-C₄-alkyl group, as defined above, attached via a sulfinyl group to the remainder of the molecule. “C₁-C₆-Alkylsulfinyl” is a C₁-C₆-alkyl group, as defined above, attached via a sulfinyl group to the remainder of the molecule. C₁-C₂-Alkylsulfinyl is methylsulfinyl or ethylsulfinyl. Examples for C₁-C₃-alkylsulfinyl are, in addition to those mentioned for C₁-C₂-alkylsulfinyl, n-propylsulfinyl and 1-methylethylsulfinyl (isopropylsulfinyl). Examples for C₁-C₄-alkylsulfinyl are, in addition to those mentioned for C₁-C₃-alkylsulfinyl, butylsulfinyl, 1-methylpropylsulfinyl (sec-butylsulfinyl), 2-methylpropylsulfinyl (isobutylsulfinyl) or 1,1-dimethylethylsulfinyl (tert-butylsulfinyl). Examples for C₁-C₆-alkylsulfinyl are, in addition to those mentioned for C₁-C₄-alkylsulfinyl, pentylsulfinyl, 1-methylbutylsulfinyl, 2-methylbutylsulfinyl, 3-methylbutylsulfinyl, 1,1-dimethylpropylsulfinyl, 1,2-dimethylpropylsulfinyl, 2,2-dimethylpropylsulfinyl, 1-ethylpropylsulfinyl, hexylsulfinyl, 1-methylpentylsulfinyl, 2-methylpentylsulfinyl, 3-methylpentylsulfinyl, 4-methylpentylsulfinyl, 1,1-dimethylbutylsulfinyl, 1,2-dimethylbutylsulfinyl, 1,3-dimethylbutylsulfinyl, 2,2-dimethylbutylsulfinyl, 2,3-dimethylbutylsulfinyl, 3,3-dimethylbutylsulfinyl, 1-ethylbutylsulfinyl, 2-ethylbutylsulfinyl, 1,1,2-trimethylpropylsulfinyl, 1,2,2-trimethylpropylsulfinyl, 1-ethyl-1-methylpropylsulfinyl or 1-ethyl-2-methylpropylsulfinyl.

The term “alkylsulfonyl” refers to alkyl group, as defined above, attached via a sulfonyl group [S(═O)₂] to the remainder of the molecule. “C₁-C₂-Alkylsulfonyl” is a C₁-C₂-alkyl group, as defined above, attached via a sulfonyl group to the remainder of the molecule. “C₁-C₃-Alkylsulfonyl” is a C₁-C₃-alkyl group, as defined above, attached via a sulfonyl group to the remainder of the molecule. “C₁-C₄-Alkylsulfonyl” is a C₁-C₄-alkyl group, as defined above, attached via a sulfonyl group to the remainder of the molecule. “C₁-C₆-Alkylsulfonyl” is a C₁-C₆-alkyl group, as defined above, attached via a sulfonyl group to the remainder of the molecule. C₁-C₂-Alkylsulfonyl is methylsulfonyl or ethylsulfonyl. Examples for C₁-C₃-alkylsulfonyl are, in addition to those mentioned for C₁-C₂-alkylsulfonyl, n-propylsulfonyl and 1-methylethylsulfonyl (isopropylsulfonyl). Examples for C₁-C₄-alkylsulfonyl are, in addition to those mentioned for C₁-C₃-alkylsulfonyl, butylsulfonyl, 1-methylpropylsulfonyl (sec-butylsulfonyl), 2-methylpropylsulfonyl (isobutylsulfonyl) or 1,1-dimethylethylsulfonyl (tert-butylsulfonyl). Examples for C₁-C₆-alkylsulfonyl are, in addition to those mentioned for C₁-C₄-alkylsulfonyl, pentylsulfonyl, 1-methylbutylsulfonyl, 2-methylbutylsulfonyl, 3-methylbutylsulfonyl, 1,1-dimethylpropylsulfonyl, 1,2-dimethylpropylsulfonyl, 2,2-dimethylpropylsulfonyl, 1-ethylpropylsulfonyl, hexylsulfonyl, 1-methylpentylsulfonyl, 2-methylpentylsulfonyl, 3-methylpentylsulfonyl, 4-methylpentylsulfonyl, 1,1-dimethylbutylsulfonyl, 1,2-dimethylbutylsulfonyl, 1,3-dimethylbutylsulfonyl, 2,2-dimethylbutylsulfonyl, 2,3-dimethylbutylsulfonyl, 3,3-dimethylbutylsulfonyl, 1-ethylbutylsulfonyl, 2-ethylbutylsulfonyl, 1,1,2-trimethylpropylsulfonyl, 1,2,2-trimethylpropylsulfonyl, 1-ethyl-1-methylpropylsulfonyl or 1-ethyl-2-methylpropylsulfonyl.

The term “alkylcarbonyl” refers to alkyl group, as defined above, attached via a carbonyl group [C(═O)] to the remainder of the molecule. “C₁-C₂-Alkylcarbonyl” is a C₁-C₂-alkyl group, as defined above, attached via a carbonyl group to the remainder of the molecule. “C₁-C₃-Alkylcarbonyl” is a C₁-C₃-alkyl group, as defined above, attached via a carbonyl group to the remainder of the molecule. “C₁-C₄-Alkylcarbonyl” is a C₁-C₄-alkyl group, as defined above, attached via a carbonyl group to the remainder of the molecule. “C₁-C₆-Alkylcarbonyl” is a C₁-C₆-alkyl group, as defined above, attached via a carbonyl group to the remainder of the molecule. C₁-C₂-Alkylcarbonyl is methylcarbonyl or ethylcarbonyl. Examples for C₁-C₃-alkylcarbonyl are, in addition to those mentioned for C₁-C₂-alkylcarbonyl, n-propylcarbonyl and 1-methylethylcarbonyl (isopropylcarbonyl). Examples for C₁-C₄-alkylcarbonyl are, in addition to those mentioned for C₁-C₃-alkylcarbonyl, butylcarbonyl, 1-methylpropylcarbonyl (sec-butylcarbonyl), 2-methylpropylcarbonyl (isobutylcarbonyl) or 1,1-dimethylethylcarbonyl (tert-butylcarbonyl). Examples for C₁-C₆-alkylcarbonyl are, in addition to those mentioned for C₁-C₄-alkylcarbonyl, pentylcarbonyl, 1-methylbutylcarbonyl, 2-methylbutylcarbonyl, 3-methylbutylcarbonyl, 1,1-dimethylpropylcarbonyl, 1,2-dimethylpropylcarbonyl, 2,2-dimethylpropylcarbonyl, 1-ethylpropylcarbonyl, hexylcarbonyl, 1-methylpentylcarbonyl, 2-methylpentylcarbonyl, 3-methylpentylcarbonyl, 4-methylpentylcarbonyl, 1,1-dimethylbutylcarbonyl, 1,2-dimethylbutylcarbonyl, 1,3-dimethylbutylcarbonyl, 2,2-dimethylbutylcarbonyl, 2,3-dimethylbutylcarbonyl, 3,3-dimethylbutylcarbonyl, 1-ethylbutylcarbonyl, 2-ethylbutylcarbonyl, 1,1,2-trimethylpropylcarbonyl, 1,2,2-trimethylpropylcarbonyl, 1-ethyl-1-methylpropylcarbonyl or 1-ethyl-2-methylpropylcarbonyl.

The term “alkoxycarbonyl” refers to alkoxy group, as defined above, attached via a carbonyl group [C(═O)] to the remainder of the molecule. “C₁-C₂-Alkoxycarbonyl” is a C₁-C₂-alkoxy group, as defined above, attached via a carbonyl group to the remainder of the molecule. “C₁-C₃-Alkoxycarbonyl” is a C₁-C₃-alkoxy group, as defined above, attached via a carbonyl group to the remainder of the molecule. “C₁-C₄-Alkoxycarbonyl” is a C₁-C₄-alkoxy group, as defined above, attached via a carbonyl group to the remainder of the molecule. “C₁-C₆-Alkoxycarbonyl” is a C₁-C₆-alkoxy group, as defined above, attached via a carbonyl group to the remainder of the molecule. C₁-C₂-Alkoxycarbonyl is methoxycarbonyl or ethoxycarbonyl. Examples for C₁-C₃-alkoxycarbonyl are, in addition to those mentioned for C₁-C₂-alkoxycarbonyl, n-propoxycarbonyl and 1-methylethoxycarbonyl (isopropoxycarbonyl). Examples for C₁-C₄-alkoxycarbonyl are, in addition to those mentioned for C₁-C₃-alkoxycarbonyl, butoxycarbonyl, 1-methylpropoxycarbonyl (sec-butoxycarbonyl), 2-methylpropoxycarbonyl (isobutoxycarbonyl) or 1,1-dimethylethoxycarbonyl (tert-butoxycarbonyl). Examples for C₁-C₆-alkoxycarbonyl are, in addition to those mentioned for C₁-C₄-alkoxycarbonyl, pentoxycarbonyl, 1-methylbutoxycarbonyl, 2-methylbutoxycarbonyl, 3-methylbutoxycarbonyl, 1,1-dimethylpropoxycarbonyl, 1,2-dimethylpropoxycarbonyl, 2,2-dimethylpropoxycarbonyl, 1-ethylpropoxycarbonyl, hexoxycarbonyl, 1-methylpentoxycarbonyl, 2-methylpentoxycarbonyl, 3-methylpentoxycarbonyl, 4-methylpentoxycarbonyl, 1,1-dimethylbutoxycarbonyl, 1,2-dimethylbutoxycarbonyl, 1,3-dimethylbutoxycarbonyl, 2,2-dimethylbutoxycarbonyl, 2,3-dimethylbutoxycarbonyl, 3,3-dimethylbutoxycarbonyl, 1-ethylbutoxycarbonyl, 2-ethylbutoxycarbonyl, 1,1,2-trimethylpropoxycarbonyl, 1,2,2-trimethylpropoxycarbonyl, 1-ethyl-1-methylpropoxycarbonyl or 1-ethyl-2-methylpropoxycarbonyl.

“Amino” is —NH₂.

“C₁-C₄-alkylamino” is a group —N(H)—C₁-C₄-alkyl, where C₁-C₄-alkyl is as defined above Examples are methylamino, ethylamino, propylamino, isopropylamino, butylamino and the like.

The term “di(C₁-C₄-alkyl)amino” denotes a group —N(C₁-C₄-alkyl)₂, where each C₁-C₄-alkyl is independently as defined above. Examples are dimethylamino, diethylamino, ethyl methylamino, dipropylamino, diisopropylamino, methyl propylamino, methylisopropylamino, ethylpropylamino, ethylisopropylamino, dibutylamino and the like.

“Aminocarbonyl” is —C(O)—NH₂.

The term “C₁-C₄-alkylaminocarbonyl” denotes a group —C(═O)—N(H)—C₁-C₄-alkyl, where C₁-C₄-alkyl is as defined above Examples are methylaminocarbonyl, ethylaminocarbonyl, propylaminocarbonyl, iso propylaminocarbonyl, butylaminocarbonyl and the like.

The term “di(C₁-C₄-alkyl)aminocarbonyl” is a group —C(═O)—N(C₁-C₄-alkyl)₂, where each C₁-C₄-alkyl is independently as defined above. Examples are dimethylaminocarbonyl, diethylaminocarbonyl, ethylmethylaminocarbonyl, dipropylaminocarbonyl, diisopropylaminocarbonyl, methylpropylaminocarbonyl, methylisopropylaminocarbonyl, ethylpropylaminocarbonyl, ethylisopropylaminocarbonyl, dibutylaminocarbonyl and the like.

Alkylene is a linear or branched divalent alkanediyl radical. C₁-C₃-Alkylene is a linear or branched divalent alkyl radical having 1, 2 or 3 carbon atoms. Examples are —CH₂—, —CH₂CH₂—, —CH(CH₃)—, —CH₂CH₂CH₂—, —CH(CH₃)CH₂—, —CH₂CH(CH₃)— and —C(CH₃)₂—.

C₃-Alkylene is a linear or branched divalent alkyl radical having 3 carbon atoms. Examples are —CH₂CH₂CH₂—, —CH(CH₃)CH₂—, —CH₂CH(CH₃)— and —C(CH₃)₂—.

C₁-C₄-Alkylene is a linear or branched divalent alkyl radical having 1, 2, 3 or 4 carbon atoms. Examples are —CH₂—, —CH₂CH₂—, —CH(CH₃)—, —CH₂CH₂CH₂—, —CH(CH₃)CH₂—, —CH₂CH(CH₃)—, —C(CH₃)₂—, —CH₂CH₂CH₂CH₂—, —CH(CH₃)CH₂CH₂—, —CH₂CH₂CH(CH₃)—, —C(CH₃)₂CH₂—, and —CH₂C(CH₃)₂—.

Linear or branched C₂-C₄-alkylene is a linear or branched divalent alkyl radical having 2, 3 or 4 carbon atoms. Examples are —CH₂CH₂—, —CH(CH₃)—, —CH₂CH₂CH₂—, —CH(CH₃)CH₂—, —CH₂CH(CH₃)—, —C(CH₃)₂—, —CH₂CH₂CH₂CH₂—, —CH(CH₃)CH₂CH₂—, —CH₂CH₂CH(CH₃)—, —C(CH₃)₂CH₂— and —CH₂C(CH₃)₂—.

Linear or branched C₂-C₁₀-alkylene is a linear or branched divalent alkyl radical having 2, 3, 4, 5, 6, 7, 8, 9 or 10 carbon atoms. Examples, in addition to the radicals stated above for C₂-C₄-alkylene, are —(CH₂)₅—, —(CH₂)₆—, —(CH₂)₇—, —(CH₂)₈—, —(CH₂)₉—, —(CH₂)₁₀— and positional isomers thereof.

Linear or branched C₁-C₁₀-alkylene is a linear or branched divalent alkyl radical having 1, 2, 3, 4, 5, 6, 7, 8, 9 or 10 carbon atoms. One example, in addition to the radicals stated above for C₂-C₁₀-alkylene, is methylene (—CH₂—).

Linear or branched C₆-C₁₀-alkylene is a linear or branched divalent alkyl radical having 6, 7, 8, 9 or 10 carbon atoms. Examples are —(CH₂)₆—, —(CH₂)₇—, —(CH₂)₈—, —(CH₂)₉—, —(CH₂)₁₀— and positional isomers thereof.

Alkenylene is a linear or branched divalent alkenediyl radical, e.g. C₂-C₄-alkenylene, which is in turn a linear or branched divalent alkenyl radical having 2, 3 or 4 carbon atoms. Examples are —CH═CH—, —CH═CH—CH₂—, —CH₂—CH═CH—, —CH═CH—CH₂—CH₂—, —CH₂—CH═CH—CH₂—, and —CH₂—CH₂—CH═CH—.

Alkynylene is a linear or branched divalent alkynediyl radical, e.g. C₂-C₄-alkynylene, which is in turn a linear or branched divalent alkynyl radical having 2, 3 or 4 carbon atoms. Examples are —C≡C—, —C≡C—CH₂—, —CH₂—C≡C—, —C≡C—CH₂—CH₂—, —CH₂—C≡C—CH₂—, and —CH₂—CH₂—C≡C—.

Divalent aliphatic radicals are those which contain no cycloaliphatic, aromatic or heterocyclic constituents. Examples are alkylene, alkenylene, and alkynylene radicals.

Divalent cycloaliphatic radicals may contain one or more, e.g., one or two, cycloaliphatic radicals; however, they contain no aromatic or heterocyclic constituents. The cycloaliphatic radicals may be substituted by aliphatic radicals, but bonding sites for he NH groups (see below embodiments of the invention) are located on the cycloaliphatic radical.

Divalent aromatic radicals may contain one or more, e.g., one or two, aromatic radicals; however, they contain no cycloaliphatic or heterocyclic constituents. The aromatic radicals may be substituted by aliphatic radicals, but both bonding sites for the NH groups are located on the aromatic radical(s).

The term “3-, 4-, 5-, 6- or 7-membered saturated, partially unsaturated or maximally unsaturated heterocyclic ring containing 1, 2 or 3 heteroatoms or heteroatom groups selected from the group consisting of N, O, S, NO, SO and SO₂, as ring members” [wherein “maximum unsaturated” includes also “aromatic”] as used herein denotes monocyclic radicals, the monocyclic radicals being saturated, partially unsaturated or maximum unsaturated (including aromatic).

Unsaturated rings contain at least one C—C and/or C—N and/or N—N double bond(s). Maximally unsaturated rings contain as many conjugated C—C and/or C—N and/or N—N double bonds as allowed by the ring size. Maximally unsaturated 5- or 6-membered heteromonocyclic rings are generally aromatic. Exceptions are maximally unsaturated 6-membered rings containing O, S, SO and/or SO₂ as ring members, such as pyran and thiopyran, which are not aromatic. Partially unsaturated rings contain less than the maximum number of C—C and/or C—N and/or N—N double bond(s) allowed by the ring size. The heterocyclic ring may be attached to the remainder of the molecule via a carbon ring member or via a nitrogen ring member. As a matter of course, the heterocyclic ring contains at least one carbon ring atom. If the ring contains more than one O ring atom, these are not adjacent.

Examples of a 3-, 4-, 5-, 6- or 7-membered saturated heteromonocyclic ring include: Oxiran-2-yl, thiiran-2-yl, aziridin-1-yl, aziridin-2-yl, oxetan-2-yl, oxetan-3-yl, thietan-2-yl, thietan-3-yl, 1-oxothietan-2-yl, 1-oxothietan-3-yl, 1,1-dioxothietan-2-yl, 1,1-dioxothietan-3-yl, azetidin-1-yl, azetidin-2-yl, azetidin-3-yl, tetrahydrofuran-2-yl, tetrahydrofuran-3-yl, tetrahydrothien-2-yl, tetrahydrothien-3-yl, 1-oxotetrahydrothien-2-yl, 1,1-dioxotetrahydrothien-2-yl, 1-oxotetrahydrothien-3-yl, 1,1-dioxotetrahydrothien-3-yl, pyrrolidin-1-yl, pyrrolidin-2-yl, pyrrolidin-3-yl, pyrazolidin-1-yl, pyrazolidin-3-yl, pyrazolidin-4-yl, pyrazolidin-5-yl, imidazolidin-1-yl, imidazolidin-2-yl, imidazolidin-4-yl, oxazolidin-2-yl, oxazolidin-3-yl, oxazolidin-4-yl, oxazolidin-5-yl, isoxazolidin-2-yl, isoxazolidin-3-yl, isoxazolidin-4-yl, isoxazolidin-5-yl, thiazolidin-2-yl, thiazolidin-3-yl, thiazolidin-4-yl, thiazolidin-5-yl, isothiazolidin-2-yl, isothiazolidin-3-yl, isothiazolidin-4-yl, isothiazolidin-5-yl, 1,2,4-oxadiazolidin-2-yl, 1,2,4-oxadiazolidin-3-yl, 1,2,4-oxadiazolidin-4-yl, 1,2,4-oxadiazolidin-5-yl, 1,2,4-thiadiazolidin-2-yl, 1,2,4-thiadiazolidin-3-yl, 1,2,4-thiadiazolidin-4-yl, 1,2,4-thiadiazolidin-5-yl, 1,2,4-triazolidin-1-yl, 1,2,4-triazolidin-3-yl, 1,2,4-triazolidin-4-yl, 1,3,4-oxadiazolidin-2-yl, 1,3,4-oxadiazolidin-3-yl, 1,3,4-thiadiazolidin-2-yl, 1,3,4-thiadiazolidin-3-yl, 1,3,4-triazolidin-1-yl, 1,3,4-triazolidin-2-yl, 1,3,4-triazolidin-3-yl, tetrahydropyran-2-yl, tetrahydropyran-3-yl, tetrahydropyran-4-yl, 1,3-dioxan-2-yl, 1,3-dioxan-4-yl, 1,3-dioxan-5-yl, 1,4-dioxan-2-yl, piperidin-1-yl, piperidin-2-yl, piperidin-3-yl, piperidin-4-yl, hexahydropyridazin-1-yl, hexahydropyridazin-3-yl, hexahydropyridazin-4-yl, hexahydropyrimidin-1-yl, hexahydropyrimidin-2-yl, hexahydropyrimidin-4-yl, hexahydropyrimidin-5-yl, piperazin-1-yl, piperazin-2-yl, 1,3,5-hexahydrotriazin-1-yl, 1,3,5-hexahydrotriazin-2-yl, 1,2,4-hexahydrotriazin-1-yl, 1,2,4-hexahydrotriazin-2-yl, 1,2,4-hexahydrotriazin-3-yl, 1,2,4-hexahydrotriazin-4-yl, 1,2,4-hexahydrotriazin-5-yl, 1,2,4-hexahydrotriazin-6-yl, morpholin-2-yl, morpholin-3-yl, morpholin-4-yl, thiomorpholin-2-yl, thiomorpholin-3-yl, thiomorpholin-4-yl, 1-oxothiomorpholin-2-yl, 1-oxothiomorpholin-3-yl, 1-oxothiomorpholin-4-yl, 1,1-dioxothiomorpholin-2-yl, 1,1-dioxothiomorpholin-3-yl, 1,1-dioxothiomorpholin-4-yl, azepan-1-, -2, -3- or -4-yl, oxepan-2, -3-, -4- or -5-yl, hexahydro-1,3-diazepinyl, hexahydro-1,4-diazepinyl, hexahydro-1,3-oxazepinyl, hexahydro-1,4-oxazepinyl, hexahydro-1,3-dioxepinyl, hexahydro-1,4-dioxepinyl, and the like.

Examples of a 3-, 4-, 5-, 6- or 7-membered partially unsaturated heteromonocyclic ring include: 2,3-dihydrofuran-2-yl, 2,3-dihydrofuran-3-yl, 2,4-dihydrofuran-2-yl, 2,4-dihydrofuran-3-yl, 2,3-dihydrothien-2-yl, 2,3-dihydrothien-3-yl, 2,4-dihydrothien-2-yl, 2,4-dihydrothien-3-yl, 2-pyrrolin-2-yl, 2-pyrrolin-3-yl, 3-pyrrolin-2-yl, 3-pyrrolin-3-yl, 2-isoxazolin-3-yl, 3-isoxazolin-3-yl, 4-isoxazolin-3-yl, 2-isoxazolin-4-yl, 3-isoxazolin-4-yl, 4-isoxazolin-4-yl, 2-isoxazolin-5-yl, 3-isoxazolin-5-yl, 4-isoxazolin-5-yl, 2-isothiazolin-3-yl, 3-isothiazolin-3-yl, 4-isothiazolin-3-yl, 2-isothiazolin-4-yl, 3-isothiazolin-4-yl, 4-isothiazolin-4-yl, 2-isothiazolin-5-yl, 3-isothiazolin-5-yl, 4-isothiazolin-5-yl, 2,3-dihydropyrazol-1-yl, 2,3-dihydropyrazol-2-yl, 2,3-dihydropyrazol-3-yl, 2,3-dihydropyrazol-4-yl, 2,3-dihydropyrazol-5-yl, 3,4-dihydropyrazol-1-yl, 3,4-dihydropyrazol-3-yl, 3,4-dihydropyrazol-4-yl, 3,4-dihydropyrazol-5-yl, 4,5-dihydropyrazol-1-yl, 4,5-dihydropyrazol-3-yl, 4,5-dihydropyrazol-4-yl, 4,5-dihydropyrazol-5-yl, 2,3-dihydrooxazol-2-yl, 2,3-dihydrooxazol-3-yl, 2,3-dihydrooxazol-4-yl, 2,3-dihydrooxazol-5-yl, 3,4-dihydrooxazol-2-yl, 3,4-dihydrooxazol-3-yl, 3,4-dihydrooxazol-4-yl, 3,4-dihydrooxazol-5-yl, 3,4-dihydrooxazol-2-yl, 3,4-dihydrooxazol-3-yl, 3,4-dihydrooxazol-4-yl, 2-, 3-, 4-, 5- or 6-di- or tetrahydropyridinyl, 3-di- or tetrahydropyridazinyl, 4-di- or tetrahydropyridazinyl, 2-di- or tetrahydropyrimidinyl, 4-di- or tetrahydropyrimidinyl, 5-di- or tetrahydropyrimidinyl, di- or tetrahydropyrazinyl, 1,3,5-di- or tetrahydrotriazin-2-yl, 1,2,4-di- or tetrahydrotriazin-3-yl, 2,3,4,5-tetrahydro[1H]azepin-1-, -2-, -3-, -4-, -5-, -6- or -7-yl, 3,4,5,6-tetrahydro[2H]azepin-2-, -3-, -4-, -5-, -6- or -7-yl, 2,3,4,7-tetrahydro[1H]azepin-1-, -2-, -3-, -4-, -5-, -6- or -7-yl, 2,3,6,7-tetrahydro[1H]azepin-1-, -2-, -3-, -4-, -5-, -6- or -7-yl, tetrahydrooxepinyl, such as 2,3,4,5-tetrahydro[1H]oxepin-2-, -3-, -4-, -5-, -6- or -7-yl, 2,3,4,7-tetrahydro[1H]oxepin-2-, -3-, -4-, -5-, -6- or -7-yl, 2,3,6,7-tetrahydro[1H]oxepin-2-, -3-, -4-, -5-, -6- or -7-yl, tetrahydro-1,3-diazepinyl, tetrahydro-1,4-diazepinyl, tetrahydro-1,3-oxazepinyl, tetrahydro-1,4-oxazepinyl, tetrahydro-1,3-dioxepinyl, tetrahydro-1,4-dioxepinyl and the like.

Examples of a 3-, 4-, 5-, 6- or 7-membered maximally unsaturated (including aromatic) heteromonocyclic ring are 2-furyl, 3-furyl, 2-thienyl, 3-thienyl, 1-pyrrolyl, 2-pyrrolyl, 3-pyrrolyl, 1-pyrazolyl, 3-pyrazolyl, 4-pyrazolyl, 5-pyrazolyl, 1-imidazolyl, 2-imidazolyl, 4-imidazolyl, 5-imidazolyl, 2-oxazolyl, 4-oxazolyl, 5-oxazolyl, 3-isoxazolyl, 4-isoxazolyl, 5-isoxazolyl, 2-thiazolyl, 4-thiazolyl, 5-thiazolyl, 3-isothiazolyl, 4-isothiazolyl, 5-isothiazolyl, 1,3,4-triazol-1-yl, 1,3,4-triazol-2-yl, 1,3,4-triazol-3-yl, 1,2,3-triazol-1-yl, 1,2,3-triazol-2-yl, 1,2,3-triazol-4-yl, 1,2,5-oxadiazol-3-yl, 1,2,3-oxadiazol-4-yl, 1,2,3-oxadiazol-5-yl, 1,3,4-oxadiazol-2-yl, 1,2,5-thiadiazol-3-yl, 1,2,3-thiadiazol-4-yl, 1,2,3-thiadiazol-5-yl, 1,3,4-thiadiazol-2-yl, 2-pyridinyl, 3-pyridinyl, 4-pyridinyl, 1-oxopyridin-2-yl, 1-oxopyridin-3-yl, 1-oxopyridin-4-yl, 3-pyridazinyl, 4-pyridazinyl, 2-pyrimidinyl, 4-pyrimidinyl, 5-pyrimidinyl, 2-pyrazinyl, 1,3,5-triazin-2-yl, 1,2,4-triazin-3-yl, 1,2,4-triazin-5-yl, 1,2,3,4-tetrazin-1-yl, 1,2,3,4-tetrazin-2-yl, 1,2,3,4-tetrazin-5-yl, pyran-2-yl, pyran-3-yl, pyran-4-yl, thiopyran-2-yl, thiopryran-3-yl, thiopryran-4-yl, 1-oxothiopryran-2-yl, 1-oxothiopryran-3-yl, 1-oxothiopryran-4-yl, 1,1-dioxothiopryran-2-yl, 1,1-dioxothiopryran-3-yl, 1,1-dioxothiopryran-4-yl, 2H-oxazin-2-yl, 2H-oxazin-3-yl, 2H-oxazin-4-yl, 2H-oxazin-5-yl, 2H-oxazin-6-yl, 4H-oxazin-3-yl, 4H-oxazin-4-yl, 4H-oxazin-5-yl, 4H-oxazin-6-yl, 6H-oxazin-3-yl, 6H-oxazin-4-yl, 7H-oxazin-5-yl, 8H-oxazin-6-yl, 2H-1,3-oxazin-2-yl, 2H-1,3-oxazin-4-yl, 2H-1,3-oxazin-5-yl, 2H-1,3-oxazin-6-yl, 4H-1,3-oxazin-2-yl, 4H-1,3-oxazin-4-yl, 4H-1,3-oxazin-5-yl, 4H-1,3-oxazin-6-yl, 6H-1,3-oxazin-2-yl, 6H-1,3-oxazin-4-yl, 6H-1,3-oxazin-5-yl, 6H-1,3-oxazin-6-yl, 2H-1,4-oxazin-2-yl, 2H-1,4-oxazin-3-yl, 2H-1,4-oxazin-5-yl, 2H-1,4-oxazin-6-yl, 4H-1,4-oxazin-2-yl, 4H-1,4-oxazin-3-yl, 4H-1,4-oxazin-4-yl, 4H-1,4-oxazin-5-yl, 4H-1,4-oxazin-6-yl, 6H-1,4-oxazin-2-yl, 6H-1,4-oxazin-3-yl, 6H-1,4-oxazin-5-yl, 6H-1,4-oxazin-6-yl, 1,4-dioxine-2-yl, 1,4-oxathiin-2-yl, 1H-azepine, 1H-[1,3]-diazepine, 1H-[1,4]-diazepine, and the like.

Examples for 5- or 6-membered monocyclic heteroaromatic rings containing 1, 2, 3 or 4 heteroatoms selected from the group consisting of N, O and S as ring members are 2-furyl, 3-furyl, 2-thienyl, 3-thienyl, 1-pyrrolyl, 2-pyrrolyl, 3-pyrrolyl, 1-pyrazolyl, 3-pyrazolyl, 4-pyrazolyl, 5-pyrazolyl, 1-imidazolyl, 2-imidazolyl, 4-imidazolyl, 5-imidazolyl, 2-oxazolyl, 4-oxazolyl, 5-oxazolyl, 3-isoxazolyl, 4-isoxazolyl, 5-isoxazolyl, 2-thiazolyl, 4-thiazolyl, 5-thiazolyl, 3-isothiazolyl, 4-isothiazolyl, 5-isothiazolyl, 1,3,4-triazol-1-yl, 1,3,4-triazol-2-yl, 1,3,4-triazol-3-yl, 1,2,3-triazol-1-yl, 1,2,3-triazol-2-yl, 1,2,3-triazol-4-yl, 1,2,5-oxadiazol-3-yl, 1,2,3-oxadiazol-4-yl, 1,2,3-oxadiazol-5-yl, 1,3,4-oxadiazol-2-yl, 1,2,5-thiadiazol-3-yl, 1,2,3-thiadiazol-4-yl, 1,2,3-thiadiazol-5-yl, 1,3,4-thiadiazol-2-yl, 2-pyridinyl, 3-pyridinyl, 4-pyridinyl, 1-oxopyridin-2-yl, 1-oxopyridin-3-yl, 1-oxopyridin-4-yl, 3-pyridazinyl, 4-pyridazinyl, 2-pyrimidinyl, 4-pyrimidinyl, 5-pyrimidinyl, 2-pyrazinyl, 1,3,5-triazin-2-yl, 1,2,4-triazin-3-yl, 1,2,4-triazin-5-yl, 1,2,3,4-tetrazin-1-yl, 1,2,3,4-tetrazin-2-yl, 1,2,3,4-tetrazin-5-yl and the like.

An “aromatic ring or ring system” in terms of the present invention is carboaromatic; i.e. it contains no heteroatoms as ring members. It is monocyclic or a condensed system, in which at least one of the rings is aromatic, i.e. conforms to the Hückel 4n+2π electrons rule. Examples are phenyl, naphthyl, anthracenyl, phenanthrenyl, indanyl, indenyl and fluorenyl.

A “heteroaromatic ring or ring system” in terms of the present invention contains at least one heteroatom or heteroatom group selected from the group consisting of N, O, S, NO, SO and SO₂ as ring member. It is monocyclic or a condensed system in which at least one of the rings is aromatic. Examples for monocyclic heteroaromatic rings are the above listed 5- or 6-membered monocyclic heteroaromatic rings. Examples for condensed systems are the following:

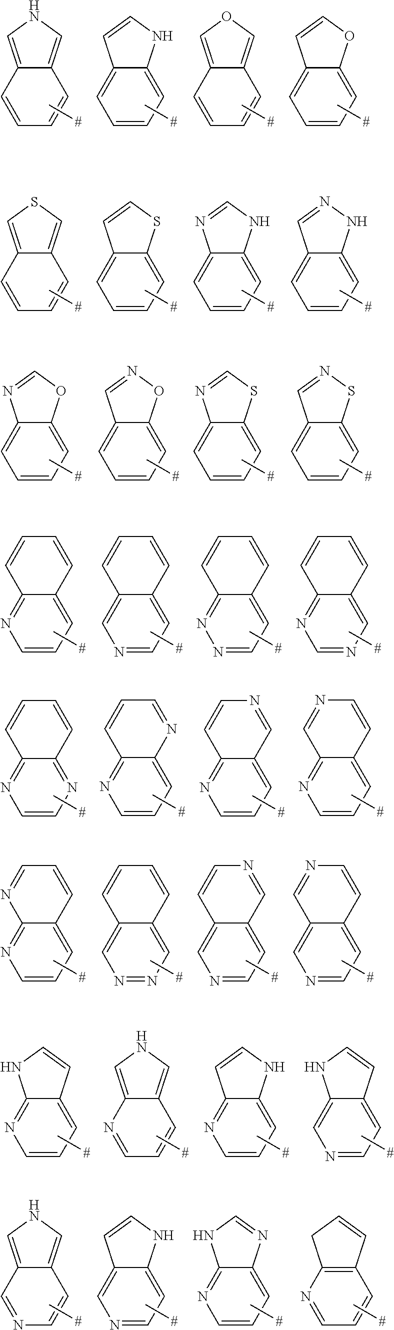

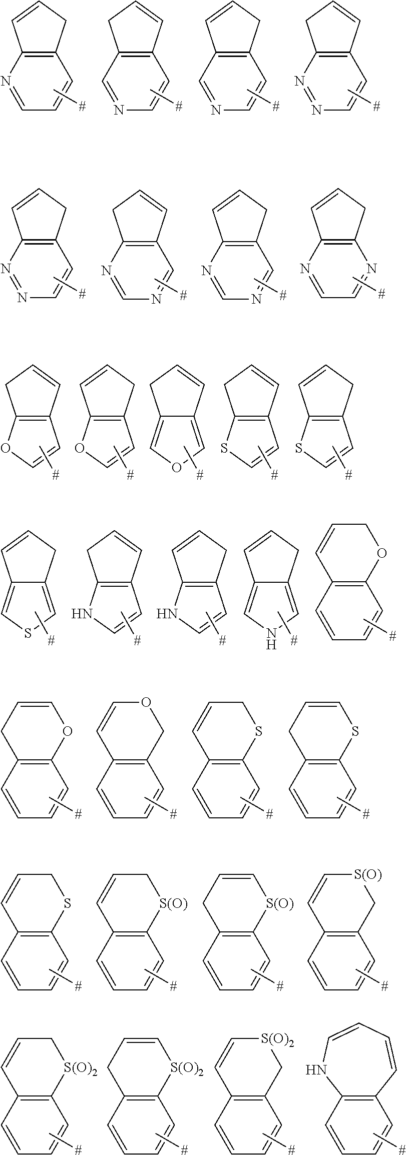

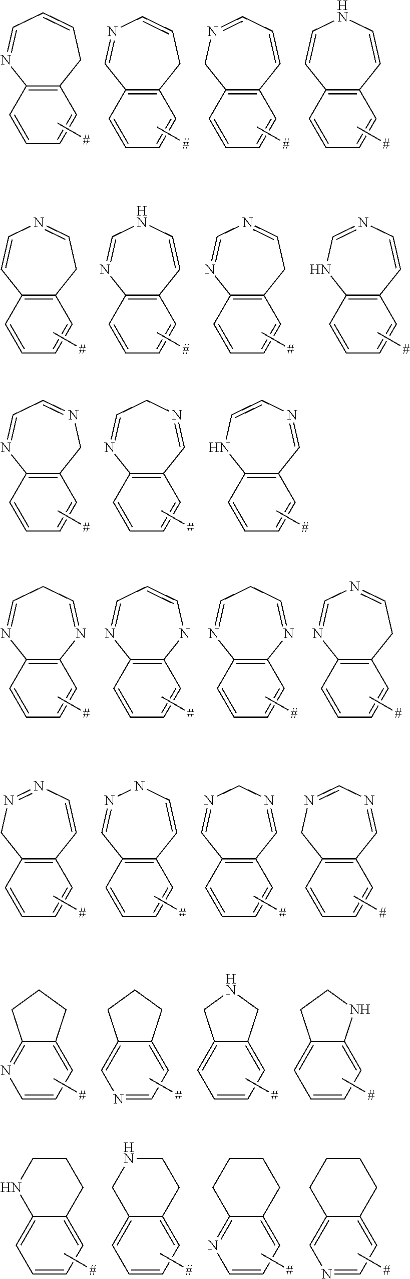

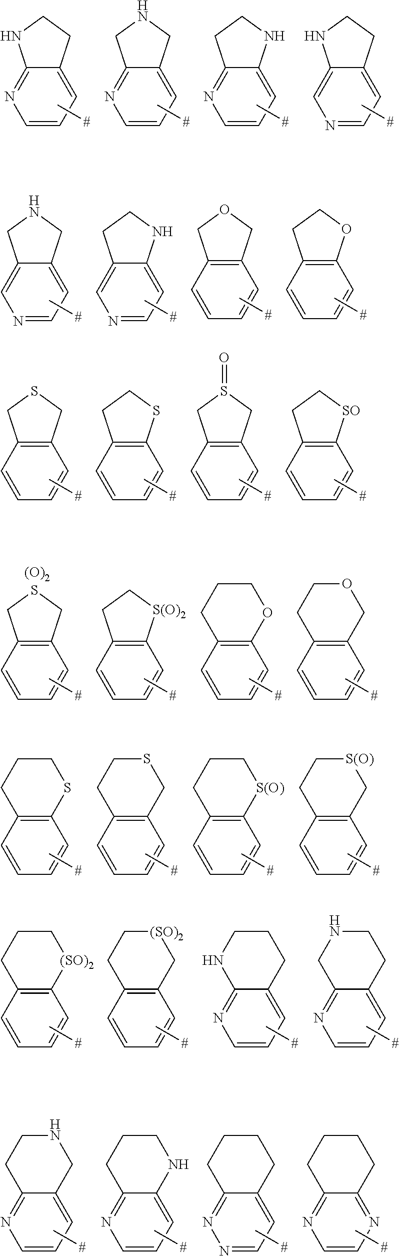

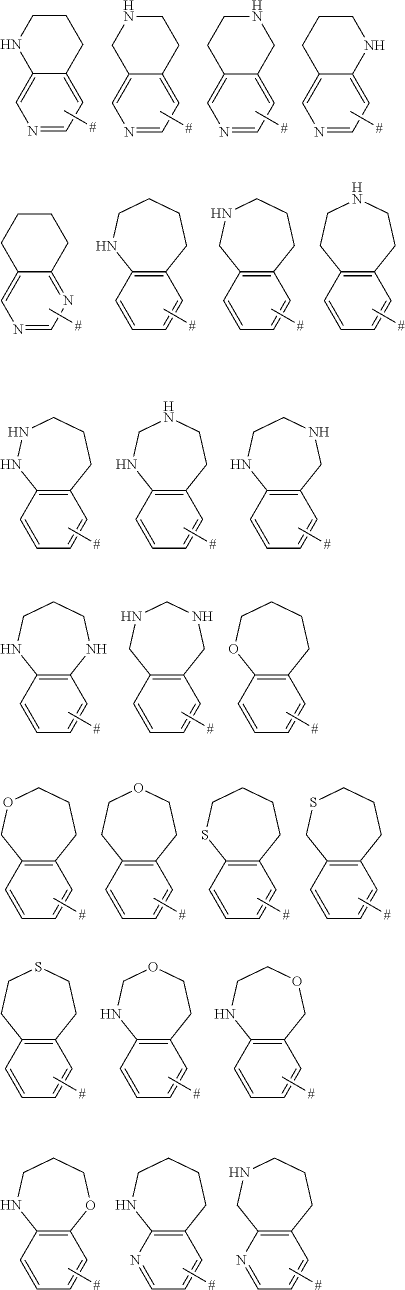

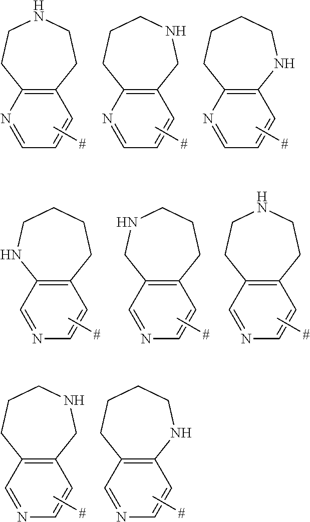

In the above structures # denotes the attachment point to the remainder of the molecule. The attachment point is not restricted to the ring on which this is shown, but can be on either of the two rings, and may be on a carbon or on a nitrogen ring atom. If the rings carry one or more substituents, these may be bound to carbon and/or to nitrogen ring atoms.

The stabilizer composition of the invention is liquid. This means that the composition is liquid at 25° C. (and 1013 mbar, but the pressure is of course essentially irrelevant in case of liquids). “Liquid at 25° C.” in the terms of the present invention means that the composition has a viscosity of at most 250 Pa·s at 25° C. and 1013 mbar, as measured with a CAP 2000+ Viscometer (Brookfield), cone 4, according to DIN EN ISO 3219, annex B at a shear rate of 100 s⁻¹. Preferably, the composition has a viscosity of at most 200 Pa·s at 25° C., more preferably of at most 200 Pa·s at 25° C., in particular of at most 150 Pa·s at 25° C., more particularly of at most 100 Pa·s at 25° C., even more particularly of at most 50 Pa·s at 25° C., specifically of at most 10 Pas at 25° C. The viscosities relate to values as obtained with the method described above. The viscosities relate moreover to values obtained at 1013 mbar.

Alike, the at least one liquid light stabilizer (a) is liquid, which means that it is liquid at 25° C. (and 1013 mbar, but the pressure is of course essentially irrelevant). “Liquid at 25° C.” in the terms of the present invention means that the stabilizer has a viscosity of at most 250 Pa·s at 25° C. and 1013 mbar, as measured with a CAP 2000+ Viscometer (Brookfield), cone 4, according to DIN EN ISO 3219, annex B at a shear rate of 100 s⁻¹. Preferably, the stabilizer has a viscosity of at most 200 Pa·s at 25° C., more preferably of at most 200 Pa·s at 25° C., in particular of at most 150 Pa·s at 25° C., more particularly of at most 100 Pa·s at 25° C., even more particularly of at most 50 Pa·s at 25° C., specifically of at most 10 Pa·s at 25° C., and very specifically of at most 1 Pa·s at 25° C. The viscosities relate to values as obtained with the method described above. The viscosities relate moreover to values obtained at 1013 mbar.

Analogously, the at least one UV absorber (c) is liquid, which means that it is liquid at 25° C. (and 1013 mbar, but the pressure is of course essentially irrelevant). “Liquid at 25° C.” in the terms of the present invention means that the UV absorber has a viscosity of at most 250 Pa·s at 25° C. and 1013 mbar, as measured with a CAP 2000+ Viscometer (Brookfield), cone 4, according to DIN EN ISO 3219, annex B at a shear rate of 100 s⁻¹. Preferably, the stabilizer has a viscosity of at most 200 Pa·s at 25° C., more preferably of at most 200 Pa·s at 25° C., in particular of at most 150 Pa·s at 25° C., more particularly of at most 100 Pa·s at 25° C., even more particularly of at most 50 Pa·s at 25° C., specifically of at most 10 Pa·s at 25° C., and very specifically of at most 5 Pa·s at 25° C. The viscosities relate to values as obtained with the method described above. The viscosities relate moreover to values obtained at 1013 mbar.

In terms of the present invention, a “finished” product, e.g. a “finished” sealant or adhesive, denotes a product, e.g. a sealant or adhesive, that after application has obtained its final properties.

The term “polymer” as used in context with the silyl-modified polymer, e.g. the silyl-terminated polymer, denotes both a prepolymer (as present in the composition B before curing) that is cured after application as well as the cured polymer.

In terms of the present invention, a sealant or adhesive composition refers to any composition which can be used to produce a connection between two or more articles or bodies, or which is suitable for filling openings, seams or spaces in, on or between one or more articles or bodies (for example grooves, holes, cracks, joints, spaces between adjacent or overlapping articles, pores and seams). Thus, sealants are used, for example, for filling spaces caused by adjacent or overlapping structures, such as, for instance, window joints and sanitary joints or else joints in automotive, aircraft or watercraft construction, and also construction joints, civil engineering joints and flooring joints. In specific embodiments the sealants can also be used to make surfaces smooth or, in the form of a sealing compound, to prevent the ingress or egress of moisture, chemicals or gases through the aforementioned openings, joints or cavities, the aforementioned properties not constituting necessary features of the stated adhesives and sealants. Sealants and adhesives are non-curable or curable. In the present case, the sealants and adhesives of the invention cure during or after application.

The below remarks made to the light stabilizer (a), the light stabilizer (b), the UV absorber (c) and further optional components contained in the stabilizer composition A apply both to the stabilizer composition A as well as to the polymer composition B of the invention and to their uses and methods of using them.

The below remarks made to the preferred and particular embodiments of the light stabilizer (a), the light stabilizer (b), the UV absorber (c), the silyl-modified polymer or further optional components, e.g. components (d) or (e), contained in the compositions of the invention as well as to their uses apply both as taken alone and, in particular, in any conceivable combination with each other.

(a) Sterically Hindered Amines (HALS) in which the Amino Group Carries a Basicity-Reducing Substituent, Having a Molecular Weight of at Most 1500 g/Mol

The liquid light stabilizer of component (a); i.e. the sterically hindered amine (HALS) in which the amino group carries a basicity-reducing substituent and has a molecular weight of at most 1500 g/mol, is termed in the following also as sterically hindered amine (a) or HALS (a) or HALS compound (b). If component (a) contains more than one HALS (a), the molecular weight criterion applies to each of these HALS compounds.

HALS (a) has generally a molecular weight of at least 150 g/mol, i.e. of from 150 to 1500 g/mol. Preferably, the liquid light stabilizer of component (a) has a molecular weight of at most 1000 g/mol, in particular from 150 to 1000 g/mol, and has more preferably a molecular weight of at most 800 g/mol, in particular of from 150 to 800 g/mol.

HALS are derivatives of 2,2,6,6-tetraalkyl piperidine, mostly 2,2,6,6-tetramethyl piperidine, and are well known in the art. If the ring nitrogen atom of the piperidine ring is substituted by hydrogen or alkyl, its basicity is rather high. The basicity can be reduced by appropriate substituents which reduce the electron density on the nitrogen atom. Suitable substituents are for example alkoxy, alkenyloxy, alkynyloxy, cycloalkoxy, phenyloxy or benzyloxy groups and carbonyl or thiocarbonyl groups either bound directly or flexibly in γ- or δ-position to the nitrogen ring atom so that an intramolecular 5- or 6-membered ring can be formed by interaction of N with the C(═O) or C(═S) group. If the carbonyl or thiocarbonyl groups is bound flexibly in γ- or δ-position to the nitrogen ring atom, this results in following bonding situation: N-A-C(═X), where N is the amino nitrogen atom of the HALS, X is O or S and A is a 3- or 4-membered bridging group. The bridging group may be an alkylene group which may contain an oxygen atom, e.g. a group —(CH₂)ₙ— or —(CH₂)ₚ—O—, where O is bound to C(═X), n is 3 or 4 and p is 2 or 3.

Preferably, the HALS compounds (a) have a pK_{b} value of at least 7, specifically of from 7 to 10.

In a preferred embodiment, the sterically hindered amine (a) is selected from the group consisting of
compounds of the formula (I)

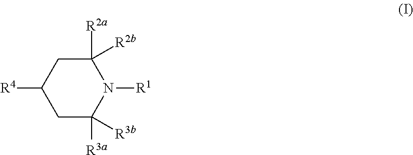

where
R¹ is a group -A-C(═X)—R⁵ or a group —OR⁶;
R^{2a}, R^{2b}, R^{3a} and R^{3b}, independently of each other, are C₁-C₃-alkyl;
R⁴ is selected from the group consisting of hydrogen, C₁-C₁₂-alkyl which may carry one or more substituents R⁷; —OR⁸, —S(O)ₘR⁹, —NR^{10a}R^{10b}, —C(═O)R¹¹ and —C(═S)R¹¹;
R⁵ is selected from the group consisting of C₁-C₁₂-alkyl which may carry one or more substituents R⁷; —OR⁸, and —NR^{10a}R^{10b};
R⁶ is selected from the group consisting of C₁-C₁₂-alkyl which may carry one or more substituents R⁷; and —C(═O)—C₁-C₈-alkyl, where the alkyl moiety may carry one or more substituents R⁷;
each R⁷ is independently selected from the group consisting of —OR⁸, —OSO₂R⁸, —S(O)ₘR⁹, —N(R^{10a})R^{10b}, —C(═O)N(R^{10a})R^{10b}, —C(═S)N(R^{10a})R^{10b}, —C(═O)OR⁸, —CH═NOR⁸, —Si(R¹²)₃, C₃-C₆-cycloalkyl, optionally substituted with one or more substituents R¹³, phenyl, optionally substituted with 1, 2, 3, 4 or 5 substituents R¹³, and a 3-, 4-, 5-, 6- or 7-membered saturated, partially unsaturated or maximally unsaturated heterocyclic ring comprising 1, 2 or 3 heteroatoms or heteroatom groups selected from the group consisting of N, O, S, NO, SO and SO₂, as ring members, where the heterocyclic ring is optionally substituted with one or more substituents R¹³;
each R⁸ is independently selected from the group consisting of hydrogen, C₁-C₁₂-alkyl which may carry one or more substituents R^{m}; and —C(═O)—C₁-C₁₂-alkyl, where the alkyl moiety may carry one or more substituents R^{m};
each R⁹ is independently selected from the group consisting of hydrogen, C₁-C₁₂-alkyl which may carry one or more substituents R¹⁴; and C₁-C₁₂-alkoxy;
R^{10a} and R^{10b}, independently of each other and independently of each occurrence, are selected from the group consisting of hydrogen, C₁-C₁₂-alkyl which may carry one or more substituents R¹⁴; and C₁-C₁₂-alkoxy;
each R¹¹ is independently selected from the group consisting of hydrogen, C₁-C₁₂-alkyl which may carry one or more substituents R¹⁴; and C₁-C₁₂-alkoxy;
each R¹² is independently selected from the group consisting of C₁-C₁₂-alkyl which may carry one or more substituents R¹⁴; and C₁-C₁₂-alkoxy;
each R¹³ is independently selected from the group consisting of hydroxyl, cyano, C₁-C₄-alkyl and C₁-C₄-alkoxy, or two R¹³ bound on the same carbon atom of a cycloalkyl ring or a heterocyclic ring may form together a group ═O;
each R¹⁴ is independently selected from the group consisting of —Si(R¹⁵)₃, hydroxyl, cyano, C₁-C₁₂-alkoxy, amino, C₁-C₄-alkylamino, di-(C₁-C₄-alkyl)-amino, aminocarbonyl, C₁-C₄-alkylaminocarbonyl, di(C₁-C₄-alkyl)-aminocarbonyl, C₁-C₄-alkylcarbonyl, C₁-C₄-alkoxycarbonyl, C₃-C₆-cycloalkyl, optionally substituted with 1, 2, 3, 4 or 5 substituents R¹³, phenyl, optionally substituted with 1, 2, 3, 4 or 5 substituents R¹³, and a 3-, 4-, 5-, 6- or 7-membered saturated, partially unsaturated or maximally unsaturated heterocyclic ring comprising 1, 2 or 3 heteroatoms or heteroatom groups selected from the group consisting of N, O, S, NO, SO and SO₂, as ring members, where the heterocyclic ring is optionally substituted with one or more substituents R¹³;
each R¹⁵ is independently selected from the group consisting of C₁-C₁₂-alkyl and C₁-C₁₂-alkoxy;
A is —(CH₂)ₙ— or —(CH₂)ₚ—O—, where O is bound to C(═X);
X is O or S;
m is 0, 1 or 2;
n is 3 or 4; and
p is 2 or 3;
   compounds of formula (II)

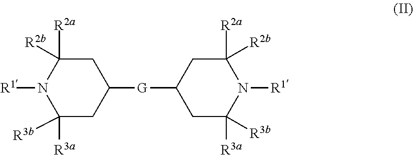

where
each R¹′ has independently one of the meanings given above for R¹;
R^{2a}, R^{2b}, R^{3a} and R^{3b}, independently of each other, are as defined above; and
G is selected from the group consisting of C₁-C₁₀-alkylene, —O—C₂-C₁₀-alkylene-O—, —C(═O)—C₁-C₁₀-alkylene-C(═O)—, and —O—C(═O)—C₁-C₁₀-alkylene-C(═O)—O—;
   and
   mixtures thereof.

In compounds I R¹ is preferably a group -A-C(═X)—R⁵. More preferably, R¹ is a group -A-C(═X)—R⁵, where
A is —(CH₂)ₚ—O—;
X is O;
R⁵ is C₁-C₁₂-alkyl; and
p is 2 or 3.

In particular, R¹ is a group —(CH₂)₂—O—C(═O)—R⁵, where
R⁵ is C₁-C₈-alkyl; in particular 2,4,4-trimethylpentyl;
R^{2a}, R^{2b}, R^{3a} and R^{3b} are methyl; and
R⁴ is a group —O—C(═O)—C₁-C₈-alkyl; in particular —O—C(═O)-(2,4,4-trimethylpentyl).

In a specific embodiment, the compound of formula I is a compound of formula I.a

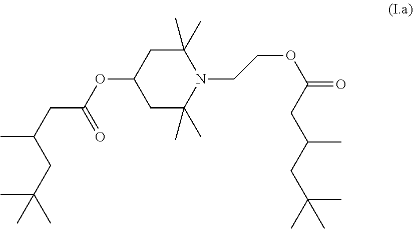 [SMILES: CC(CC(=O)OCCN1C(C)(C)CC(OC(=O)CC(C)CC(C)(C)C)CC1(C)C)CC(C)(C)C]

In a particular embodiment, in compounds II
each R¹′ is independently a group —OR⁶; where
R⁶ is C₄-C₁₂-alkyl; and
G is —O—C(═O)—C₆-C₁₀-alkylene-C(═O)—O—.

In a specific embodiment, the compound of formula II is a compound of formula II.a

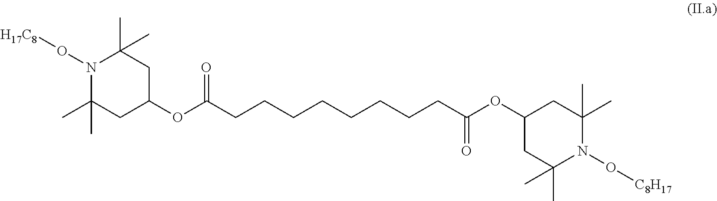

In particular, the liquid light stabilizer of component (a) is selected from the group consisting of the compound of formula (I.a), the compound of formula (II.a) and mixtures thereof.

HALS compounds in which the nitrogen atom of the piperidinyl ring is directly bound to an oxygen atom are more prone to oxidation, and thus applications containing such compounds tend to yellow over time. Therefore, more preference is given to compounds I or II as HALS (a), wherein R¹ is a group -A-C(═X)—R⁵, and, consequently, among compounds I.a and II.a, more preference is given to compound I.a as HALS (a), especially for application forms in which a yellowing is optically disturbing.

Sterically hindered amines (a), especially those of formulae I and II, and methods for preparing them are known and are for example commercialized under the Tinuvin® brands of BASF SE.

(b) Sterically Hindered Amines (HALS) Having a Molecular Weight of More than 1500 g/Mol

The light stabilizer of component (b); i.e. the sterically hindered amine (HALS) in which the amino group carries a basicity-reducing substituent and has a molecular weight of more than 1500 g/mol, is termed in the following also as sterically hindered amine (b) or HALS (b) or HALS compound (b). If component (b) contains more than one HALS (b), the molecular weight criterion applies to each of these HALS compounds.

HALS (b) has generally a molecular weight of at most 30,000 g/mol, i.e. of more than 1500 to 30,000 g/mol. Preferably, the liquid light stabilizer of component (b) has a molecular weight of at least 1700 g/mol, in particular of from 1700 to 30,000 g/mol. More preferably, the liquid light stabilizer of component (b) has a molecular weight of at least 2500 g/mol, in particular of from 2500 to 20,000 g/mol; even more preferably of at least 2800 g/mol, in particular of from 2800 to 10,000 g/mol, specifically of from 2800 to 8000 g/mol or from 2800 to 5000 g/mol.

If the HALS (b) is not a discrete molecule, but an oligomer or polymer with a molecular weight distribution (i.e. a polydispersity PD>1; PD=M_{w}/Mₙ), the molecular weight values relate to the weight average molecular weight M_{w}.

If not mentioned otherwise, in terms of the present invention, the values for the weight-average molecular weight M_{w} (and also for the number-average molecular weight Mₙ, where applicable) are determined as follows: If the product is commercially available, the values are generally as indicated by the producer or provider. In all other cases, the values are as determined with gel permeation chromatography (GPC), also termed size-exclusion chromatography (SEC), using a polystyrene standard. This is by the way generally also the determination method for the commercial products.

In particular, the following conditions apply: Standard: polystyrene (PS) with narrow molar mass standards (PS molar mass range 580-7500000 g/mol, PSS). Hexylbenzene (162 g/mol) is used as a low molar mass marker. Extrapolation is used to estimate the molecular weight distribution outside the range of these calibration standards with respect to the exclusion and permeation limits.

Eluent: THF+0.1% trifluoroacetic acid

Flow rate: 1 mL/min

Injection volume: 100 μl

Concentration: 2 mg/ml

The sample solutions are filtered prior to analysis over Sartorius Minisart SRP 25 (0.2 μm).

Column temperature: 35° C.

Column combination of PLgel pre-column/PLgel MIXED-B

Detector: DRI Agilent 1100.

Depending inter alia on their specific molecular weight, the HALS compounds (b) can be medium to highly viscous or solid, but are generally solid.

In a preferred embodiment, the sterically hindered amine (b) is selected from the group consisting of
compounds of formula (III)

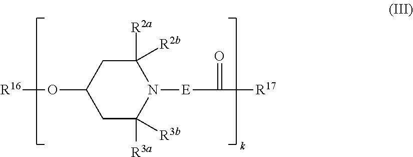

where
R^{2a}, R^{2b}, R^{3a} and R^{3b}, independently of each other, are C₁-C₃-alkyl;
E is —(CH₂)ₙ—, —(CH₂)ₚ—O—, where O is bound to C(═O), —(CH₂)ₙ—C(═O)-E¹-, or —(CH₂)ₚ—O—C(═O)-E¹-, where
n is 3 or 4;
p is 2 or 3; and
E¹ is linear or branched C₁-C₁₀-alkylene;
R¹⁶ is hydrogen or C₁-C₄-alkyl;
R¹⁷ is hydrogen, C₁-C₄-alkyl or C₁-C₄-alkoxy; and
k is 3 to 50;
where in particular R^{2a}, R^{2b}, R^{3a} and R^{3b} are methyl, E is —CH₂CH₂—O—C(═O)—CH₂CH₂—, R¹⁶ is hydrogen, R¹⁷ is methoxy, and k is from 10 to 15
   compounds of formula (IV)

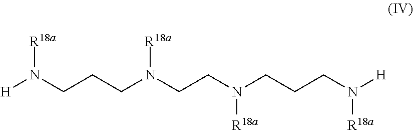

where R^{18a} is:

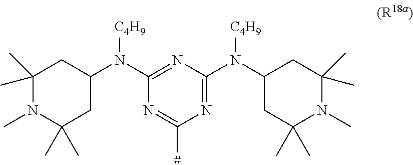

where C₄H₉ is n-butyl and # denotes the attachment point to the nitrogen atom to which R^{18a} is bound,
compounds of formula (V)

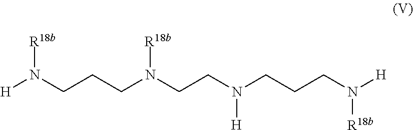

where R^{18b} is:

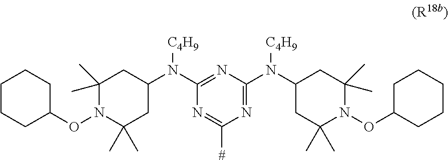

where C₄H₉ is n-butyl and # denotes the attachment point to the nitrogen atom to which R^{18b} is bound,
compounds of formula (VI)

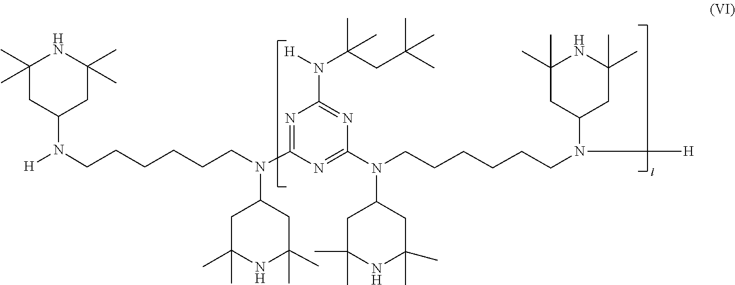

where
I is from 2 to 5;
   compounds of formula (VII)

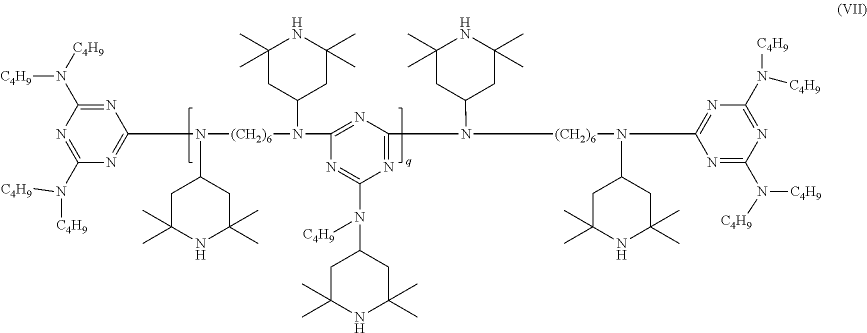

where
q is from 2 to 5; and
C₄H₉ is n-butyl;
   compounds of formula (VIII)

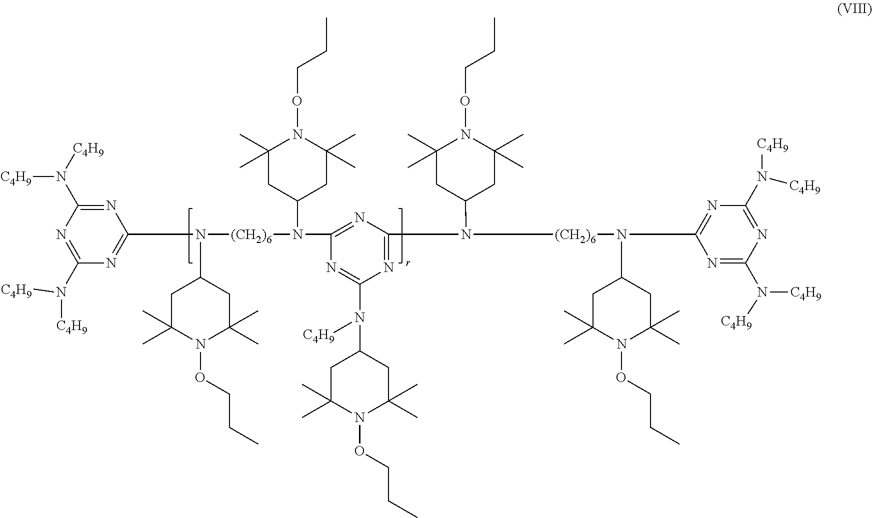

where
r is from 3 to 5; and
C₄H₉ is n-butyl;
   and
   mixtures thereof.

Preferably, the light stabilizer (b) is selected from sterically hindered amines (HALS) in which the amino group carries a basicity-reducing substituent. If the HALS compounds (b) contain more than one piperidinyl ring, the nitrogen ring atom of every piperidinyl ring carries a basicity-reducing substituent. Preferably, the HALS compounds (b) have a pK_{b} value of at least 7, specifically of from 7 to 10.

Thus, among the above compounds (III) to (VIII), preference is given to compounds of formula (III), compounds of formula (V) and compounds of formula (VIII). In compounds of formula (III), preferably R^{2a}, R^{2b}, R^{3a} and R^{3b} are methyl, E is —CH₂CH₂—O—C(═O)—CH₂CH₂—, R¹⁶ is hydrogen, R¹⁷ is methoxy, and k is from 10 to 15. Thus, among the above compounds (III) to (VIII), more preference is given to compounds of formula (III) in which R^{2a}, R^{2b}, R^{3a} and R^{3b} are methyl, E is —CH₂CH₂—O—C(═O)—CH₂CH₂—, R¹⁶ is hydrogen, R¹⁷ is methoxy, and k is from 10 to 15, compounds of formula (V) and compounds of formula (VIII).

In an alternative embodiment, the light stabilizer of component (b) is selected from the group consisting of compounds of formula (III) in which R^{2a}, R^{2b}, R^{3a} and R^{3b} are methyl, E is —CH₂CH₂—O—C(═O)—CH₂CH₂—, R¹⁶ is hydrogen, R¹⁷ is methoxy, and k is from 10 to 15; compounds of formula (IV), compounds of formula (VII) and compounds of formula (VIII); and in particular from compounds of formula (III) in which R^{2a}, R^{2b}, R^{3a} and R^{3b} are methyl, E is —CH₂CH₂—O—C(═O)—CH₂CH₂—, R¹⁶ is hydrogen, R¹⁷ is methoxy, and k is from 10 to 15; and compounds of formula (VII).

Most preference is given to compounds of formula (III), in particular to compounds of formula (III) in which R^{2a}, R^{2b}, R^{3a} and R^{3b} are methyl, E is —CH₂CH₂—O—C(═O)—CH₂CH₂—, R¹⁶ is hydrogen, R¹⁷ is methoxy, and k is from 10 to 15.

Sterically hindered amines (b), especially those of formulae III to VIII, and methods for preparing them are known and are for example commercialized under the Tinuvin® or Chimassorb® brands of BASF SE.

In a particular embodiment, component (a) is the compound of formula (I.a), and component (b) is a compound of formula (III), wherein R^{2a}, R^{2b}, R^{3a} and R^{3b} are methyl, E is —CH₂CH₂—O—C(═O)—CH₂CH₂—, R¹⁶ is hydrogen, R¹⁷ is methoxy, and k is from 10 to 15.

Preferably, the weight ratio of component (a) to component (b) is of from 10:1 to 1:10, more preferably from 5:1 to 1:5, in particular from 3:1 to 1:3, more particularly from 3:1 to 1:1 and specifically from 2.5:1 to 1.5:1.

(c) Liquid UV Absorber

The liquid UV absorber of component (c) is preferably selected from the group consisting of cyanoacrylates, benzotriazoles, hydroxyphenyl triazines and formamidines which are liquid at 25° C. Mixtures of these compounds are also suitable.

Suitable cyanoacrylates are compounds of the formula (IX)

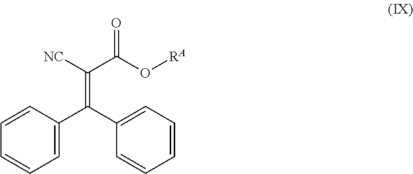

where
R^{A} is C₁-C₁₀-alkyl; and is in particular 2-ethylhexyl.

Suitable benzotriazoles are compounds of the formula (X)

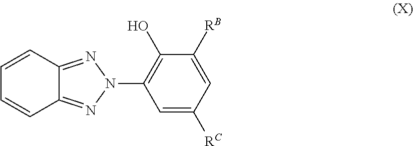

wherein
R^{B} is C₁-C₁₄-alkyl;
R^{C} is selected from the group consisting of C₁-C₄-alkyl and —CH₂CH₂—C(═O)—O—R^{C1};
   and
R^{C1} is C₁-C₁₀-alkyl;
   and where in particular R^{B} is C₁₂H₂₅ and R^{C} is methyl; or R^{B} is tert-butyl and R^{C} is —CH₂CH₂—C(═O)—O—C₈H₁₇;
   and compounds of formula (XI)

R^{D}—(OCH₂CH₂)ₛ—R^{E} (XI)

where
R^{D} is a group of the formula (XII)

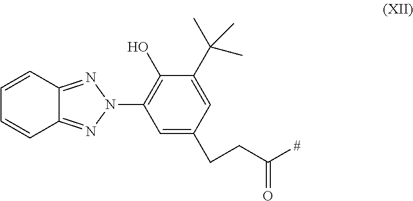

where # denotes the attachment point to the remainder of the molecule;
R^{E} is R^{D} or OH; and
s is 6 to 7.

Suitable hydroxyphenyltriazines are compounds of the formula (XIII) or (XIV)

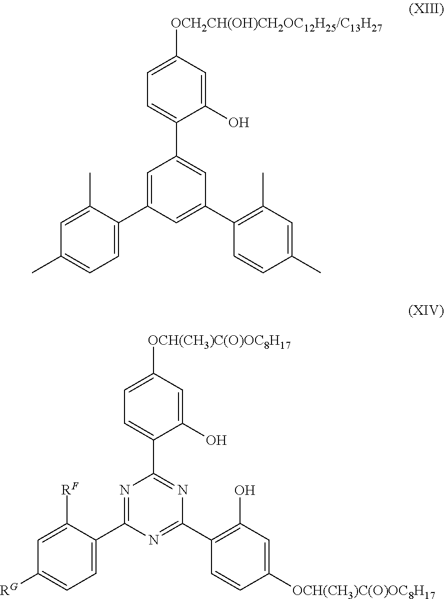

where
R^{F} and R^{G} are both OH, or are both OCH(CH₃)C(O)OC₈H₁₇ or R^{F} is OH and R^{G} is OCH(CH₃)C(O)OC₈H₁₇.

A suitable formamidine is the compound of the formula (XV)

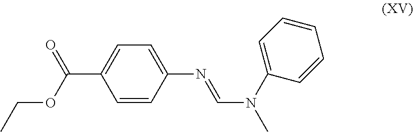 [SMILES: CCOC(=O)c1ccc(/N=C/N(C)c2ccccc2)cc1]

In a more preferred embodiment, the UV absorber of component (c) is selected from the group consisting of:
cyanoacrylates of the formula (IX)

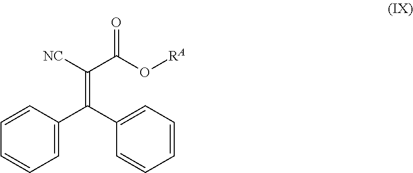

where
R^{A} is C₁-C₁₀-alkyl; and is in particular 2-ethylhexyl;
   benzotriazoles of the formula (X)

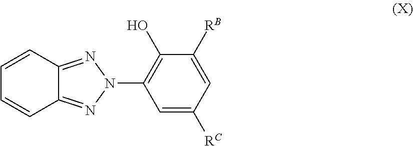

wherein
R^{B} is C₁-C₁₄-alkyl;
R^{C} is selected from the group consisting of C₁-C₄-alkyl and —CH₂CH₂—C(═O)—O—R^{C1}; and
R^{C1} is C₁-C₁₀-alkyl;
where in particular R^{B} is C₁₂H₂₅ and R^{C} is methyl; or R^{B} is tert-butyl and R^{C} is —CH₂CH₂—C(═O)—O—C₈H₁₇;
   benzotriazoles of the formula (XI)

R^{D}—(OCH₂CH₂)ₛ—R^{E} (XI)

where
R^{D} is a group of the formula (XII)

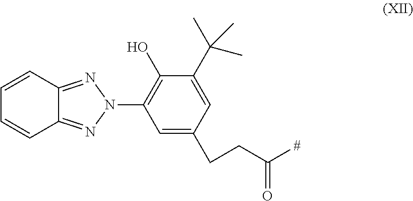

where # denotes the attachment point to the remainder of the molecule;
R^{E} is R^{D} or OH; and
s is 6 to 7;
   hydroxyphenyltriazines of the formula (XIII)

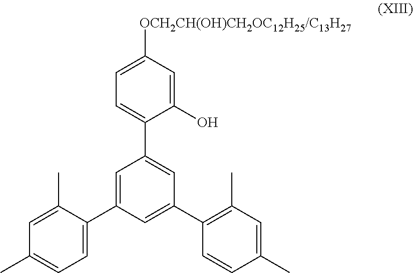

hydroxyphenyltriazines of the formula (XIV)

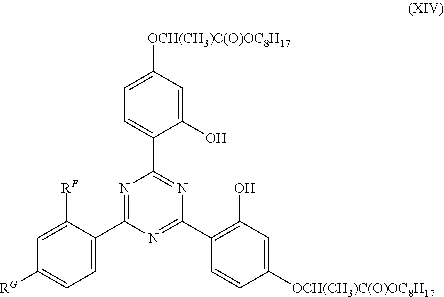

where
R^{F} and R^{G} are both OH, or are both OCH(CH₃)C(O)OC₈H₁₇ or R^{F} is OH and R^{G} is OCH(CH₃)C(O)OC₈H₁₇;
   the formamidine of the formula (XV)

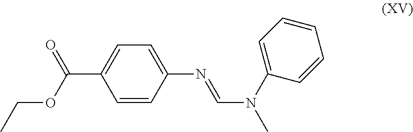 [SMILES: CCOC(=O)c1ccc(/N=C/N(C)c2ccccc2)cc1]

and
mixtures thereof;

In particular, the UV absorber of component (c) is selected from the group consisting of:
the cyanoacrylate of the formula (IX), wherein R^{A} is 2-ethylhexyl;
the benzotriazole of the formula (XI), wherein R^{E} is R^{D};
the benzotriazole of the formula (XI), wherein R^{E} is OH; and
mixtures of the benzotriazole of the formula (XI), wherein R^{E} is R^{D} and the benzotriazole of the formula (XI), wherein R^{E} is OH.

Specifically, the UV absorber of component (c) is the cyanoacrylate of the formula (IX), wherein R^{A} is 2-ethylhexyl.

In a particular embodiment, component (a) is the compound of formula (La), component (b) is a compound of formula (III), wherein R^{2a}, R^{2b}, R^{3a} and R^{3b} are methyl, E is —CH₂CH₂—O—C(═O)—CH₂CH₂—, R¹⁶ is hydrogen, R¹⁷ is methoxy, and k is from 10 to 15 and component (c) is the cyanoacrylate of the formula (IX), wherein R^{A} is 2-ethylhexyl.

Liquid UV absorbers (c), especially those of formulae IX to XV, and methods for preparing them are known and are for example commercialized under the Tinuvin® or Uvinul® brands of BASF SE.

The weight ratio of component (a) and component (c) is preferably of from 10:1 to 1:10, more preferably from 5:1 to 1:5, in particular from 3:1 to 1:3, more particularly from 3:1 to 1:1 and specifically from 2.5:1 to 1.5:1.

Further Components

In a specific embodiment), the stabilizing composition of the invention, in addition to components (a), (b) and (c), further comprises an antioxidant (d).

(d) Antioxidant

Component (d) is preferably a phenolic antioxidant, i.e. a compound containing a phenol ring.

The phenolic antioxidant is preferably selected from the group consisting of:
compounds of the formula (XVI)

R²⁰—O-A¹-O—R²¹ (XVI)
compounds of the formula (XVII)

R²⁰—[O—(CH₂)₂]ₜ—OR²⁰ (XVII)
compounds of the formula (XVIII)

R²⁰—N(H)-A²-N(H)—R²⁰ (XVIII)
compounds of the formula (XIX)

C(CH₂—O—R²⁰)₄ (XIX)

where in compounds (XVI) to (XIX)
R²⁰ is a group of the formula (XX)

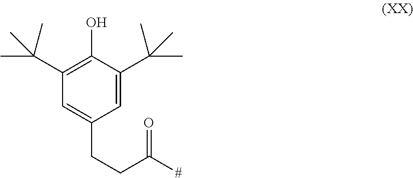

where # denotes the attachment point to the remainder of the molecule;
R²¹ is R²⁰ or C₁-C₁₀-alkyl;
A¹ is (CH₂)ᵤ or —(CH₂)₂—S—(CH₂)₂—;
A² is a covalent bond or (CH₂);
t is from 1 to 4; and
u is from 2 to 8;
   compounds of the formula (XXI)

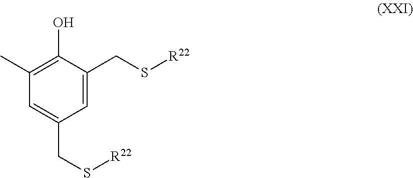

where either both R²² are C₈H₁₇ or both are C₁₂H₂₅;
the compound of the formula (XXII)

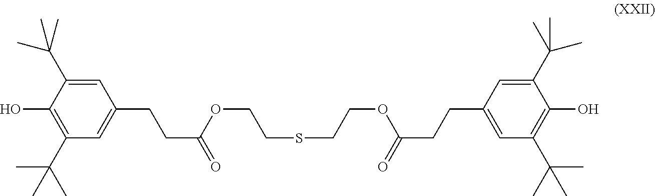 [SMILES: CC(C)(C)c1cc(CCC(=O)OCCSCCOC(=O)CCc2cc(C(C)(C)C)c(O)c(C(C)(C)C)c2)cc(C(C)(C)C)c1O]

the compound of the formula (XXIII)

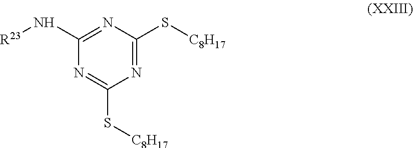

the compound of the formula (XXIV)

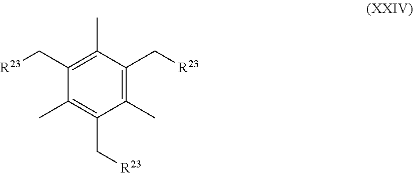

the compound of the formula (XXV)

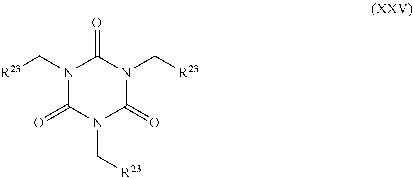

where in compounds (XXIII), (XXIV) and (XXV) R²³ is a group of the formula (XXVI)

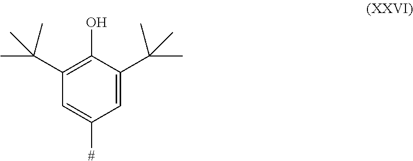

where # denotes the attachment point to the remainder of the molecule;
and
mixtures thereof;

The phenolic antioxidant is in particular selected from the group consisting of compounds of the formula XXI, compounds of the formula XXII, compounds of the formula XXIII, compounds of the formula XXIV and compounds of the formula XXV. Specifically, the phenolic antioxidant is a compound of formula XXI.

Phenolic antioxidants (d), especially those of formulae XVI to XXV, and methods for preparing them are known and are for example commercialized under the Irganox® brands of BASF SE.

The stabilizer composition may contain one or more further additives (e) which are different from components (a) to (d). The further additives (e) are preferably selected among usual additives for stabilizer compositions:

(e.1) rheology modifiers;
(e.2) desiccants
(e.3) flame retardants
(e.4) radical scavengers
(e.5) metal deactivators
(e.6) antiozonants
(e.7) peroxide decomposers/scavangers
(e.8) blowing agents
(e.9) antistatics
(e.10) adhesion promoters
(e.11) chelates
(e.12) fillers
(e.13) corrosion inhibitors
(e.14) pigments
(e.15) antifoams
(e.16) curing/crosslinking catalysts
(e.17) photolatent initiators
(e.18) plasticizers
(e.1) Rheology modifiers are for example thixotropic agents, like polyamide waxes, hydrogenated castor oil derivatives, metal soaps (e.g. calcium, barium or aluminum stearate), fatty acid amides and swellable polymers like PVC.
(e.2) Desiccants are for example silica, zeolithes, calcium sulfate, sodium sulfate and various silanes, such as vinylsilanes (e.g. vinyltrimethoxysilane), oxime silanes, benzamidosilanes, carbamatosilanes and alkoxysilanes.
(e.3) Flame retardants are for example halogen containing compounds such as tetrabromobisphenol A, decabromodiphenyl oxide, decabromodiphenyl ethane, brominated carbonate oligomers, brominated epoxy oligomers, and poly(bromostyrenes). Further examples are the hydroxides, oxides and oxide hydrates of group 2, 4, 12, 13, 14 and 15 (semi)metals, such as magnesium oxide or hydroxide, aluminium oxide, aluminum trihydrate, silica, tin oxide, antimony oxide (III and V) and oxide hydrate, titanium oxide and zinc oxide or oxide hydrate; nitrogen-based flame retardants, such as melamine and urea based resins and melamine cyanurate, melamine phosphates, melamine polyphosphates and melamine borate; and phosphorous-based flame retardants, such as ammonium polyphosphates, phosphoric esters, in particular triarylphosphates, such as triphenyl phosphate, tribenzyl phosphate, tricresyl phosphate, tri-(dimethylphenyl) phosphate, benzyl dimethylphosphate, di-(dimethylphenyl) phenyl phosphate, resorcinol-bis(diphenyl phosphate), recorcinol-bis-[di-(2,6-dimethylphenyl)-phosphate] (PX-200), aluminum diethylphosphinate (Exolit® OP 1230), but also aliphatic phosphates, such as tris(2-chloroisopropyl)phosphate (Lupragen® TCPP), aromatic polyphosphates, e.g. polyphosphates derived from bisphenols, such as the compounds described in US 2004/0249022), and phosphonic esters, such as dimethyl-methyl phosphonate and phosphonic acid (2-((hydroxymethyl)carbamypethyl) dimethylester, and polycyclic phosphorous-containing compounds, such as 9,10-dihydro-9-oxa-10-phosphaphenanthrene-10-oxide (DOPO).
(e.4) Radical scavengers are for example nitroxyl compounds, such as 2,2,6,6-tetramethylpiperidinyloxyl (TEMPO) and derivatives thereof or hydroxylamines, such as NRR′OH, where R and R′, independently of each other, are long-chain alkyl groups, e.g. alkyl groups with 4 to 20 carbon atoms; aryl amines, e.g. diphenyl amines in which at least one of the phenyl rings carries a C₁-C₁₀-alkyl group; or quinone compounds.
(e.5) Metal deactivators are, for example, salicylic acid derivatives such as N,N′-disalicylidene-1,2-propanediamine, N-salicylal-N′-salicyloyl hydrazine, N,N′-bis(salicyloyl)hydrazine, 3-salicyloylamino-1,2,4-triazole, N,N′-bis(salicyl-oyl)oxalyl dihydrazide, or N,N′-bis(salicyloyl)thiopropionyl dihydrazide; hydrazine derivatives, such as N,N-bis(3,5-di-tert-butyl-4-hydroxyphenylpropionyl) hydrazine, bis(benzylidene)oxalyl dihydrazide, isophthaloyl dihydrazide, sebacoyl bisphenylhydrazide, or N,N′-diacetyladipoyl dihydrazide, further N,N′-diphenyloxamide or oxanilide, and moreover benzotriazoles or tolutriazoles, as commercialized under the Irgamet® brand of BASF.
(e.6) Antiozonants are added in order to slow the deterioration of the finished product caused by exposure to ozone. Examples are p-phenylenediamines such as 6PPP (N-(1,3-dimethylbutyl)-N′-phenyl-p-phenylenediamine) or IPPD (N-isopropyl-N′-phenyl-p-phenylenediamine); 6-ethoxy-2,2,4-trimethyl-1,2-dihydroquinoline (ETMQ), ethylene diurea (EDU), nickel dibutyl dithiocarbamate or paraffin waxes, such as Akrowax® 195.
(e.7) Peroxide deactivators (decomposers/scavangers) are for example esters of β-thiodipropionic acid, for example, the lauryl, stearyl, myristyl or tridecyl ester, mercaptobenzimidazole or the zinc salt of 2-mercaptobenzimidazole, zinc dibutyldithiocarbamate, dioctadecyl disulfide, and pentaerythritol tetrakis(β-dodecylmercapto)propionate.
(e.8) Suitable blowing agents are chemical blowing agents, which are compounds which decompose at elevated temperature to release gas. Examples are chlorinated paraffin waxes, carbamoyliminourea or [(4-methylphenyl)sulfonylamino]urea.
(e.9) Antistatics are used for reducing or eliminating buildup of static electricity. The antistatic agent makes the surface or the material itself slightly conductive, either by being conductive itself, or by absorbing moisture from the air; therefore, some humectants are suitable. The molecules of an antistatic agent often have both hydrophilic and hydrophobic areas. Examples are long-chain aliphatic amines (optionally ethoxylated) and amides, quaternary ammonium salts (e.g., behentrimonium chloride or cocamidopropyl betaine), esters of phosphoric acid, polyethylene glycol esters, or polyols; further carbon black, conductive fibers, or nanomaterials; ionic liquids or a solution of a salt in an ionic liquid; moreover indium tin oxide.
(e.10) An adhesion promoter is understood to be a substance which improves the adhesion properties (tack or stickiness) of adhesive layers on surfaces; such compounds are also known as tackifiers. Usually they are low-molecular weight compounds with high glass transition temperature. Examples for adhesion promotors useful in sealant compositions are silane adhesion promoters, in particular aminosilanes, e.g. 3-aminopropyltrimethoxysilane, and also polyethyleneimines, especially polyethyleneimines with a weight average molecular weight of at most 10000, in particular at most 5000. Examples for adhesion promotors useful in adhesive compositions are resins, terpene oligomers, coumarone/indene resins, aliphatic, petrochemical resins and modified phenolic resins. Suitable within the framework of the present invention are, for example, hydrocarbon resins, as obtained by polymerization of terpenes, principally α- or β-pinene, dipentene or limonene. The polymerization of these monomers generally takes place cationically with initiation by Friedel-Crafts catalysts. The terpene resins also include copolymers of terpenes and other monomers, e.g. styrene, α-methylstyrene, isoprene and the like. The above resins are used e.g. as adhesion promoters for pressure-sensitive adhesives and coating materials. Also suitable are the terpene-phenolic resins which are produced by acid-catalyzed addition of phenols to terpenes or rosin. Further, rosins and derivatives thereof, for example their esters or alcohols, are suitable as adhesion promoters in the above sense. Silane adhesion promoters, in particular aminosilanes, e.g. 3-aminopropyltrimethoxysilane, are also suitable; as well as polyethyleneimines, especially polyethyleneimines with a weight average molecular weight of at most 10000, in particular at most 5000.
(e.11) Chelates serve for binding metals which may otherwise influence the properties of the composition of the invention in an unintentional way at an inappropriate time. Examples are acetylacetone (acac), ethylenediamine (en), 2-(2-aminoethylamino)ethanol (AEEA), diethylenetriamine (dien), iminodiacetate (ida), triethylenetetramine (trien, TETA), triaminotriethylamine (tren), nitrilotriacetate (nta), bis(salicyliden)ethylenediamine (salen), ethylenediaminotriacetate (ted), ethylenediaminetetraacetate (EDTA), diethylenetriaminepentaacetate (DTPA), 1,4,7,10-tetraazacyclododecan-1,4,7,10-tetraacetate (DOTA), oxalate (ox), tartrate (tart), citrate (cit), dimethylglyoxim (dmg), 8-hydroxyquinoline (oxin), 2,2′-bipyridine (bpy), 1,10-phenanthroline (phen), dimercaptosuccinic acid (DMSA) or 1,2-bis(diphenylphosphino)ethane (dope).
(e.12) Fillers are for example inorganic fillers like calcium carbonate, e.g. in the form of chalk or lime dust; talc, clay, sand, quartz, flint, mica, glass powder and other ground mineral substances, ceramic microspheres, precipitated or pyrogenic silica, zeolithes, bentonites, kaolin, kieselguhr, metal oxides like titanium, iron or zinc oxide; mixed oxides of silicium and aluminum; barium sulfate, silicium nitride, silicium carbide, boron nitride, carbon black; or organic fillers like graphite powder, wood flour, sawdust, ground walnut shells and other chopped fibers like cellulose or cotton fibers.
(e.13) Corrosion inhibitors are for example the alkali metal or (substituted) ammonium salts or polycarboxylic acid, such as the salts of sebacic acid or tris(carboxyalkylamino)-1,3,5-triazines; or N-acylsarcosines. These compounds are commercialized under the Irgacor® brand of BASF.
(e.14) Pigments are for example titanium dioxide, iron oxides or carbon black.
(e.15) Antifoams or antifoaming agents of defoamers are intended to stop or suppress foaming during processing. Typically, silicones, such as dimethylsilicones, are used.
(e.16) Curing/crosslinking catalysts are for example tin-based catalysts, such as dibutyltin dilaurate (DBTL), dibutyltin dioctoate or dibutyltin diacetylacetonate, or organozinc compounds.
(e.17) The photolatent initiators are mainly used for triggering the curing of the STP. Photolatent initiators in the terms of the present invention are compounds which under the influence of light, especially UV radiation and/or visible light, are converted into compounds which can act as initiators of a chemical reaction. To be more precise, upon activation, they can activate or promote or catalyze the curing or crosslinking of polymers, especially of the polymer(s) contained in the polymer composition of the present invention; specifically the STPs. In inactivated form, the photolatent initiators have no or virtually no effect on the curing or crosslinking of polymers. Photolatent initiators which become active with UV C radiation, UV B radiation, UV A radiation and/or radiation in the visible range are suitable, and can be photolatent bases (PLB), photolatent acid generators (FAG) or photolatent metal-based initiators.

Examples for suitable PLBs are the compounds of formulae PLB.1 to PLB.7:

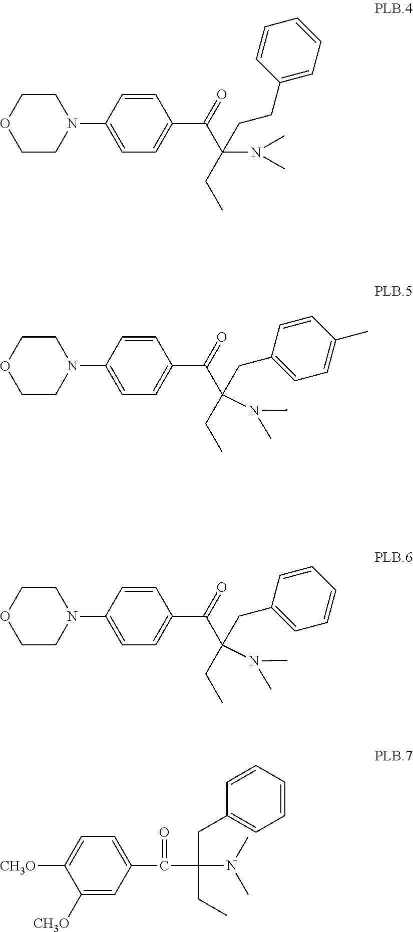

where
each R²⁴ is independently selected from C₁-C₆-alkyl, C₁-C₆-alkoxy, C₁-C₆-alkylthio, C₁-C₆-alkylsulfinyl, C₁-C₆-alkylsulfonyl, C₁-C₆-alkylcarbonyl and C₁-C₆-alkoxycarbonyl;
R²⁵ is selected from hydrogen and C₁-C₄-alkyl; and
s is 0, 1, 2, 3, 4 or 5;
   in particular PLB.1, PLB.2, PLB.6 and PLB.7, and specifically PLB.1, where R²⁴ is C₁-C₆-alkoxycarbonyl, specifically methoxycarbonyl, s is 0 or 1 and R²⁵ is hydrogen, and where specifically, s is 1 and R²⁴ is bound in para-position to CHR²⁵, or s is 0.

It may be advantageous to use additionally a photosensitizer which eases the photoactivation of the photolytically cleavable group, such as benzophenone, thioxanthone, 4,4′-bis(dimethylamino)benzophenone, 4,4′-bis-(diethylamino)benzophenone, 4,4′-bis(ethylmethylamino)benzophenone, 4,4′-diphenylbenzophenone, 4,4′-diphenoxybenzophenone, 4,4′-bis(p-isopropylphenoxy)benzophenone, 4-methylbenzophenone, 2,4,6-trimethylbenzophenone, 4-phenylbenzophenone, 2-methoxycarbonylbenzophenone, 4-benzoyl-4′-methyldiphenylsulfide, 4-methoxy-3,3′-methylbenzophenone, isopropylthioxanthone, chlorothioxanthone, 1-chloro-4-propoxythioxanthone, 2,4-dimethylthioxanthone, 2,4-diethylthioxanthone and 1,3-dimethyl-2-(2-ethylhexyloxy)thioxanthone as well as mixtures of the above compounds; or 3-acylcoumarines, e.g. 3-benzoylcoumarine, 3-benzoyl-7-methoxycoumarine, 3-benzoyl-5,7-di(propoxy)coumarine, 3-benzoyl-6,8-dichlorcoumarine, 3-benzoyl-6-chlorcoumarine, 3, 3′-carbonylbis[5,7-di(propoxy)coumarine], 3,3′-carbonylbis(7-methoxycoumarine), 3,3′-carbonyl bis(7-diethylaminocoumarine), 3-isobutyroylcoumarine, 3-benzoyl-5,7-dimethoxycoumarine, 3-benzoyl-5,7-diethoxycoumarine, 3-benzoyl-5,7-dibutoxycoumarine, 3-benzoyl-5,7-di(methoxyethoxy)coumarine, 3-benzoyl-5,7-di (allyloxy)coumarine, 3-benzoyl-7-dimethylaminocoumarine, 3-benzoyl-7-diethylaminocoumarine, 3-isobutyroyl-7-dimethylaminocoumarine, 5,7-dimethoxy-3-(1-naphthoyl)coumarine, 5,7-dimethoxy-3-(1-naphthoyl)coumarine, 3-benzoylbenzo[f]coumarine, 7-diethylamino-3-thienoylcoumarine, or 3-(4-cyanobenzoyl)-5,7-dimethoxycoumarine; or 3-(aroylmethylen)thiazolines, e.g. 3-methyl-2-benzoylmethylennaphthothiazoline, 3-methyl-2-benzoylmethylenbenzothiazoline, or 3-methyl-2-propionylmethylen-p-naphthothiazoline; or other carbonyl compounds, e.g. acetophenone, 3-methoxyacetophenone, 4-phenylacetophenone, 2-acetylnaphthaline, 2-naphthaldehyde, 9,10-anthraquinone, 9-fluorenon, dibenzosuberone, xanthone, 2,5-bis(4-diethylaminobenzylidene)cyclopentanone, 2-(4-dimethylaminobenzylidene)indan-1-one or 3-(4-dimethylaminophenyl)-1-indan-S-yl-propenone, 3-phenylthiophthalimide or N-methyl-3,5-di(ethylthio)phthalimide.

Suitable PAGs are compounds A^{b}-Z^{b}, where A^{b} and Z^{b} are covalently bound, and where A^{b} is derived from a strong acid selected from aliphatic and aromatic sulfonic acids, and Z^{b} is a photolytically removable group. More particularly, the PAGs are oxime sulfonates, in particular oxime sulfonates of following formula PAG.1:

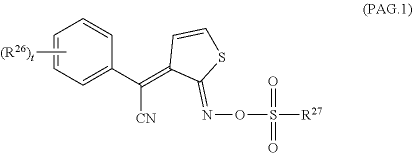

where
each R²⁶ is independently selected from C₁-C₆-alkyl, C₁-C₆-alkoxy, C₁-C₆-alkylthio, C₁-C₆-alkylsulfinyl, C₁-C₆-alkylsulfonyl, C₁-C₆-alkylcarbonyl and C₁-C₆-alkoxycarbonyl;
R²⁷ is selected from C₁-C₁₂-alkyl, C₃-C₆-cycloalkyl and phenyl, where phenyl may carry 1, 2 or 3 substituents selected from C₁-C₆-alkyl, C₁-C₆-alkoxy, C₁-C₆-alkylthio, C₁-C₆-alkylsulfinyl, C₁-C₆-alkylsulfonyl, C₁-C₆-alkylcarbonyl and C₁-C₆-alkoxycarbonyl; and
t is 0, 1, 2, 3, 4 or 5;
   where in particular R²⁶ is C₁-C₆-alkyl, specifically methyl. In a specific embodiment t is 1 and R²⁶ is bound ortho to the —C(CN)═ group. In a specific embodiment R²⁷ is C₃-C₈-alkyl or phenyl which may carry one methyl substituent. In a more specific embodiment t is 1, R²⁶ is methyl bound ortho to the —C(CN)═ group and R²⁷ is C₃-C₈-alkyl or phenyl which carries one methyl substituent in para position to the sulfonyl group.

Other suitable PAGs are acylphosphine oxides, such as compounds of formula PAG.2:

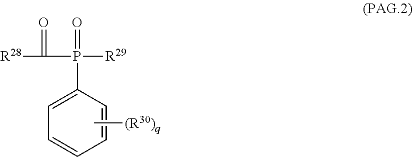

where
R²⁸ is selected from C₁-C₁₀-alkyl, C₁-C₁₀-alkoxy and phenyl which may carry 1, 2, 3, 4 or 5 substituents selected from C₁-C₆-alkyl and C₁-C₆-alkoxy;
R²⁹ is selected from C₁-C₁₀-alkyl, C₁-C₁₀-alkoxy, C(O)R³¹ and phenyl which may carry 1, 2, 3, 4 or 5 substituents selected from C₁-C₆-alkyl and C₁-C₆-alkoxy;
R³⁰ is selected from C₁-C₆-alkyl and C₁-C₆-alkoxy;
R³¹ is selected C₁-C₁₀-alkyl, C₁-C₁₀-alkoxy and phenyl which may carry 1, 2, 3, 4 or 5 substituents selected from C₁-C₆-alkyl and C₁-C₆-alkoxy; and
q is 0, 1, 2, 3, 4 or 5;
   where in particular R²⁸ is phenyl which carries 3 methyl substituents, specifically 3 methyl substituents in the 2, 4 and 6-positions, relative to the 1-position of the attachment point of the phenyl ring to C(O); R²⁹ is selected from C₁-C₆-alkoxy, C(O)R³¹ and phenyl; R³¹ is phenyl which may carry 1, 2, 3, 4 or 5 substituents selected from C₁-C₆-alkyl and C₁-C₆-alkoxy, and is in particular phenyl which carries 3 methyl substituents, specifically 3 methyl substituents in the 2, 4 and 6-positions, relative to the 1-position of the attachment point of the phenyl ring to C(O); and q is 0.

In particular, the acylphosphinoxides are selected compounds of formulae PAG.2.1, PAG.2.2 and PAG.2.3:

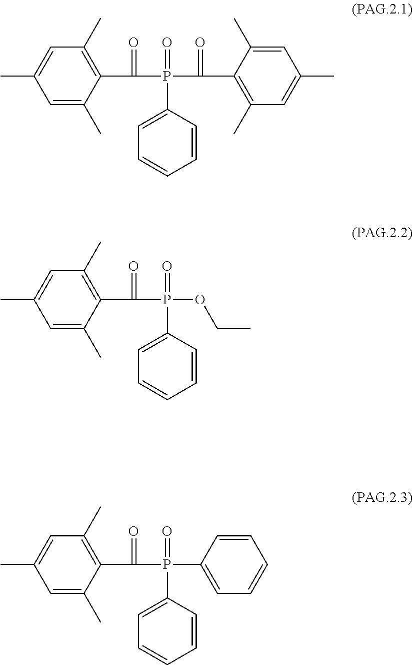

Other suitable PAGs are ionic photoacid generators, for example onium salts, such as halonium, specifically iodonium; sulfonium, sulfoxonium, selenium, ammonium, phosphonium or arsonium salts. Their counter-anions are preferably non-coordinating complex anions, such as complex anions of semimetals and metals, e.g. of B, P, As, Sb, Sn, Fe, Bi, Al, Ga. In, Ti, Zr, Sc, Cr, Hf or Cu; and also stabilized carbanions. Preference is given to iodonium and sulfonium salts, where the iodonium or sulfonium central atom is substituted by at least one aromatic ring, the iodine atom preferably by 2 aromatic rings; the sulfur atom by preferably 3 aromatic rings, where the aromatic rings may in turn be substituted, e.g. by one or more C₁-C₁₀-alkyl, C₁-C₁₀-alkoxy, C₁-C₁₀-thioalkyl, C₁-C₄-alkylcarbonyl, C₁-C₁₀-alkoxycarbonyl, aryl, aryloxy or arylthio groups, where the aryl groups in the three last-mentioned substituents may in turn carry one or more substituents selected from C₁-C₁₀-alkyl, C₁-C₁₀-alkoxy, C₁-C₁₀-thioalkyl, C₁-C₄-alkylcarbonyl and C₁-C₁₀-alkoxycarbonyl. The counter-anions are preferably selected from BF₄⁻, PF₆⁻, SbF₆⁻, B(C₆H₆)₄⁻, B(C₆F₅)₄⁻ and C(S(O)₂CF₃)₃⁻.

Specific examples for ionic PAGs are salts of formulae PAG.3.1 and PAG.3.2

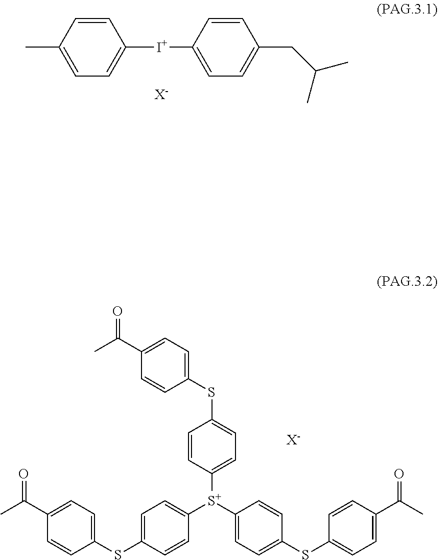

where X⁻ is selected from PF₆⁻, B(C₆F₅)₄⁻ and C(S(O)₂CF₃)₃⁻.

Metal-based photoinitiators are complexes of transition metals or of metals of the third or fourth main-group of the periodic table containing at least one photolytically removable ligand. In a preferred embodiment, they are selected from titanium complexes containing at least one photolytically removable ligand. Examples are the titanium complexes Ti(IV)(acac)₂(OiPr)₂ and Ti(0)(phenyl)₂(2,6-difluoro-4-pyrrol-1-yl-phenyl)₂.

(e.18) Suitable plasticizers are for example acrylate polymers. Preferred acrylate polymers are liquid at 25° C. (for the definition of liquid via the viscosity see definition in context with the stabilizer composition and components (a) and (c)) and have a weight-average molecular weight of at most 30000, a glass transition temperature of at most −40° C. and a viscosity of at most 250 Pa·s at 25° C. The plasticizer is preferably selected from polyacrylates containing repeating units of formula

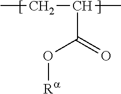

where each R^{α} is independently C₁-C₆-alkyl which may carry one substituent selected from the group consisting of hydroxy and C₁-C₄-alkoxy, and where each R^{α} is in particular independently selected from the group consisting of C₁-C₆-alkyl and C₂-C₄-hydroxyalkyl. In other words, the plasticizer is preferably selected from polymers of acrylic acid esters, where the alcohol from which the acrylic acid esters are derived are selected from compounds of formula R^{α}—OH, where R^{α} is as defined above. The polyacrylates may contain minor amounts of acrylic acid in copolymerized form. Suitable are also non-polymeric plasticizer containing carboxylate groups, such as aromatic carboxylates, aliphatic carboxylates or cycloaliphatic carboxylates. Aromatic carboxylates are for example C₄-C₁₂-alkyl phthalates, e.g. bis(2-ethylhexyl)-phthalate. Aliphatic carboxylates are for example C₄-C₁₂-alkyl adipates, e.g. bis(2-ethylhexyl)adipate or bis(2-ethyloctyl)adipate, or C₄-C₁₂-alkylcitrates, e.g. trisethylcitrate. Cycloaliphatic carboxylates are for example C₄-C₂₀-alkyl esters of cyclohexane dicarboxylic acids, in particular 1,2-cyclohexane dicarboxylic acid di-C₄-C₂₀-alkyl esters, more particularly 1,2-cyclohexane dicarboxylic acid di-C₄-C₁₂-alkyl esters, specifically 1,2-cyclohexane dicarboxylic acid diisononyl ester (DINCH). Further suitable plasticizers are polypropylene glycols of lower molecular weight such as 300-600 g/mol, e.g. 400 g/mol, like Loxanol® PL 5824.

Preference is however given to the above-described acrylate polymers.

Among the above components (e), preference is given to plasticizers (e.18), catalysts (e.16) and photolatent initiators (e.17).

In a particular embodiment, the stabilizer composition A does however not contain any component (e). At least one component (e), in particular at least one plasticizer (e.18) and/or at least one catalyst (e.16) and/or at least one photolatent initiator (e.17), may however be contained in the polymer composition B of the invention. Further details are given below.

In a preferred embodiment, the stabilizer composition A contains following components in following ratios:
(a) 2 to 80% by weight, based on the total weight of the composition, of component (a);
(b) 1 to 50% by weight, based on the total weight of the composition, of component (b);
(c) 1 to 50% by weight, based on the total weight of the composition, of component (c),
(d) 0 to 90% by weight, based on the total weight of the composition, of component (d); and
(e) 0 to 96% by weight, based on the total weight of the composition, of component (e).

The percentages by weight are based on the total weight of the stabilizer composition. The weights from (a) to (e) add up to 100% by weight.

In a particular embodiment, the stabilizer composition A contains following components in following ratios:
(a) 40 to 80% by weight, based on the total weight of the composition, of component (a);
(b) 10 to 30% by weight, based on the total weight of the composition, of component (b);
(c) 10 to 30% by weight, based on the total weight of the composition, of component (c).

The percentages by weight are based on the total weight of the stabilizer composition. The weights from (a) to (c) add up to 100% by weight.

Specifically, the stabilizer composition A contains following components in following ratios:
(a) 40 to 60% by weight, based on the total weight of the composition, of component (a);
(b) 20 to 30% by weight, based on the total weight of the composition, of component (b); and
(c) 20 to 30% by weight, based on the total weight of the composition, of component (c).

The percentages by weight are based on the total weight of the stabilizer composition. The weights from (a) to (c) add up to 100% by weight.

The stabilizer composition is liquid at 25° C. and 1013 mbar and preferably contains at most 5% by weight, in particular at most 2% by weight, more particularly at most 1% by weight, based on the total weight of the composition, of solvents. In a particular embodiment, the stabilizer composition does not contain any solvent.

“Solvent” is a liquid substance that dissolves a solute (a chemically different liquid, solid or gas), resulting in a solution. In terms of the present invention, the solvent is not restricted to a compound or medium which dissolves the solutes in the proper sense: This compound or medium may be more generally a dispersing medium, and thus the “solution” might be a suspension, emulsion or a solution in the proper sense (i.e. a homogeneous mixture composed of two or more substances, where the particles of the solute cannot be seen by naked eye and which does not scatter light). As used above, the term “solvent” does not include any of components (a) to (e), even if these are liquid and may principally act as a solvent for one or more of the other components. As used above, this term includes only liquid substances which are different from components (a) to (e) and are able to dissolve a solute.

The stabilizer composition A is prepared by principally known methods, such as intimately mixing the components, either simultaneously or consecutively, in suitable dispersing units, such as mixers, in particular high-speed mixers, planetary mixers, internal mixers, compounders, twin-screw-extruders etc.

Polymer Composition

The present invention further relates to a polymer composition B comprising
(i) at least one silyl-modified polymer, in particular at least one silyl-terminated polymer; and
(ii) a stabilizer composition A as defined above.

In other words, the polymer composition comprises
(i) at least one silyl-modified polymer, in particular at least one silyl-terminated polymer; and
(ii) at least one liquid light stabilizer selected from sterically hindered amines (HALS) in which the amino group carries a basicity-reducing substituent, the liquid light stabilizer having a molecular weight of at most 1500 g/mol [component (a)];
   at least one light stabilizer selected from sterically hindered amines (HALS) having a molecular weight of more than 1500 [component (b)];
   at least one liquid UV absorber [component (c)];
   optionally at least one antioxidant [component (d)]; and optionally at least one further additive [component (e)].

The above general definitions and description of suitable and preferred embodiments of components (a) to (e) and of their weight ratios apply here, too.

Preferably, the polymer composition comprises, in addition to the silyl-modified polymer (i) and to the mandatory components (a), (b) and (c), at least one component (d) and/or (e). More preferably, the polymer composition comprises at least one of the following components: at least one antioxidant (d), at least one plasticizer (e.18), at least one catalyst (e.16), and/or at least one photolatent initiator (e.17). In particular, the polymer composition comprises at least one plasticizer (e.18) and/or at least one catalyst (e.16).

Silyl-Modified Polymers

Silyl-modified polymers (SMPs) are polymers which contain one or more silyl groups. Generally, at least one of the substituents on the silicium atom of the silyl group is a hydrolysable group, such as alkoxy, acyloxy or oxime, and especially an alkoxy group. In the presence of atmospheric moisture, such silyl groups containing a hydrolysable group are capable of undergoing hydrolyzation/condensation reactions with each other, which results in a curing or crosslinking of the polymers. The SMPs generally contain an organic backbone. The silyl groups may be bound anywhere to the basic polymer, e.g. to one or more termini of the polymer backbone and/or as or on side chains. Silyl-modified polymers can be roughly classified as silyl-terminated polymers (STPs) and as polymers containing laterally bound silyl groups, although the definitions may overlap and many intermediate forms may exist.

Silyl-terminated polymers (STPs) are polymers, generally with an organic backbone, which contain silyl groups at the termini (chain ends) of the polymers. Generally, STPs do essentially not contain silyl side chains. “Do essentially not contain silyl side chains” means that at least 90 mol-%, preferably at least 95 mol-%, of the silyl groups present in the silyl-modified polymer are at the termini.

In case of linear polymers, the termini are the starting and end points of the polymer main chain. In case of star-shaped polymers, the termini are at the ends of the polymer main chains forming the star shape. “Main chain” indicates that some deviation of perfect linearity, i.e. some branching of the chain, may be present. In case of a more complex polymer architecture, e.g. in case of a highly branched or crosslinked polymer, the distinction between STPs and silyl-modified polymers with laterally bound silyl groups is not useful since it becomes difficult to distinguish between termini and side chains.

Silyl-modified polymers containing laterally bound silyl groups are also polymers containing an organic backbone; here, however, the essential part of the silyl groups is bound as or on side chains. A minor part of the silyl groups may however also be bound to one or more termini. “Essential part” means that at least 90 mol-%, preferably at least 95 mol-%, of the silyl groups present in the silyl-modified polymer are bound as or on side chains.

The polymer backbone of the SMPs is generally a polyether, polyester, polyamide, polyimine, polyurethane, poly(meth)acrylate, polyvinylester, polyolefin or mixed forms thereof.

STPs and methods for producing them are generally known and are inter alia described in US 2012/0238695, DE-A-102011003425, DE-A-102004018548 and the references cited therein.

Silyl-modified polymers with laterally bound silyl groups are also known and commercially available, e.g. under the Tegopac® Bond brands from Evonik; e.g. Tegopac® Bond 150, Tegopac® Bond 160, Tegopac® Bond 170 or Tegopac® Bond 251.

Preference is given to SMPs with a weight-average molecular weight M_{w} of from 350 to 30000, more preferably from 500 to 25000, even more preferably from 1000 to 22000, in particular from 5000 to 20000, specifically from 7000 to 19000.

If not mentioned otherwise, the number-average and weight-average molecular weights of SMPs are determined as follows: If the product is commercially available, the values are generally as indicated by the producer or provider. In all other cases, the values are as determined by the above described GPC/SEC method using polystyrene standards.

In a particular embodiment, STPs are used as silyl-modified polymers.

In a preferred embodiment, the silyl-terminated polymer is a polymer of formula XXVII:

[(R′)ₐ(R″O)₃₋ₐSi-L¹-Y]_{b}—Po (XXVII)

where
Po is the di-, tri- or tetravalent radical of a base polymer;
each Y is independently selected from the group consisting of a bond, —NH—C(═O)—O—, —O—C(═O)—NH—, —C(═O)—NH-L²-NH—C(═O)—NH—, —NH—C(═O)—NH-L²-NH—C(═O)—, —O—C(═O)—, —C(═O)—O—, —NH—C(═O)—S—, —S—C(═O)—NH— and —O—;
R′ and R″, independently of each other and independently of each occurrence, are selected from C₁-C₆-alkyl;
L¹ is C₁-C₄-alkylene
L² is a divalent aliphatic, cycloaliphatic or aromatic radical;
each a is independently 0 or 1; and
b is 2, 3 or 4.

If Po ends in an oxygen atom, this is not directly bound to an oxygen atom of Y. In this case, the oxygen atom of Y is to be understood to be omitted. If for instance the terminal group of Po is an oxygen atom and Y is —O—C(═O)—NH—, the group Y bound to this oxygen atom of Po is to be understood in this case to be —C(═O)—NH—, so that Po—Y is in this case in sum Po—O—C(═O)—NH—,

In a preferred embodiment, Po is the di-, tri- or tetravalent radical of a polymer selected from the group consisting of polyethers, polyesters, polyamides, polyimines, polyurethanes, poly(meth)acrylates, polyvinylesters, polyolefins and mixed forms thereof.

Polyether polymers from which Po is derived are preferably composed of repeating units
[symbol] A-O [symbol]
   where each A is independently —CH₂—CH₂—, —CH₂—CH(CH₃)—, —CH(CH₃)—CH₂—, or —(CH₂)₄—; i.e. they are derived from polyethyleneglycol, polypropyleneglycol, poly-tetrahydrofuran and mixed forms (copolymers) thereof.

Polyesters from which Po is derived are preferably composed of repeating units [symbol] B¹—C(═O)—O [symbol] or [symbol] C(═O)—B¹—C(═O)—O—B²—O

[symbol]

where B¹ and B², independently of each other, are a divalent aliphatic, alicyclic, aliphatic-alicyclic, aromatic or araliphatic radical.

Polyamides from which Po is derived are preferably composed of repeating units [symbol] B¹—C(═O)—N(R) [symbol] or [symbol] C(═O)—B¹—C(O)—N(R)—B²—N(R)

[symbol]

where B¹ and B², independently of each other, are a divalent aliphatic, alicyclic, aliphatic-alicyclic, aromatic or araliphatic radical and R is H or C₁-C₄-alkyl or is a branching point and stands for example for [symbol] B¹—C(═O)—N(R) [symbol] or [symbol] C(═O)—B¹—C(O)—N(R)—B²—N(R) [symbol] or [symbol] B²—N(R)—C(═O)—B¹—C(O)— [symbol] .

Polyimine polymers from which Po is derived are preferably composed of repeating units [symbol] A-N(R) [symbol] , where each A is independently a divalent aliphatic, alicyclic, aliphatic-alicyclic, aromatic or araliphatic radical and R is H or C₁-C₄-alkyl or is a branching point and stands for example for [symbol] A-N(R) [symbol] .

Polyurethanes from which Po is derived are preferably composed of repeating units
[symbol] B¹—O—C(═O)—N(R)—B²—N(R)—C(═O)—O [symbol]
   where B¹ and B², independently of each other, are a divalent aliphatic, alicyclic, aliphatic-alicyclic, aromatic or araliphatic radical and R is H or C₁-C₄-alkyl or is a branching point.

Poly(meth)acrylates from which Po is derived are preferably composed of repeating units
[symbol] CH₂—C(R)(C(O)OR′ [symbol]
   where R is H (polyacrylates) or methyl (methacrylates) and R′ is C₁-C₁₂-alkyl which may carry various substituents, such as OH, C₁-C₄-alkoxy, amino, C₁-C₄-alkylamino, di-(C₁-C₄)-alkylamino, CN, trimethylsilyl etc.

Polyvinylesters from which Po is derived are preferably composed of repeating units
[symbol] CH₂—CH(OR) [symbol]
   where R is C₁-C₁₂-alkyl.

Polyolefins from which Po is derived are preferably polymers of α-olefins and are preferably composed of repeating units
[symbol] CH₂—CH(R) [symbol]
   where R is H C₁-C₁₂-alkyl.

In particular, Po is the divalent radical (i.e. b is 2) of a polyether. The polyether is in particular a polyethylene glycol or polypropylene glycol, and is specifically polypropylene glycol.

In a particular embodiment, in polymer XXVII
Y is —NH—C(═O)—O— (where NH is bound to L¹);
R′ and R″, independently of each other and independently of each occurrence, are selected from the group consisting of methyl and ethyl and are in particular methyl; and
each L¹ is independently —CH₂— or C₃-alkylene, in particular —CH₂— or —CH₂CH₂CH₂—.

In a specific embodiment, polymer XXVII is a polymer of formula XXVII.1

(CH₃O)₂(CH₃)Si—CH₂—NH—C(═O)—O—[CH(CH₃)—CH₂—O—]ᵤ—C(═O)—NH—CH₂—Si(CH₃)(OCH₃)₂ (XXVII.1)

where u is from 1 to 500, preferably 10 to 400, more preferably 50 to 300, in particular from 100 to 250, specifically from 100 to 200, very specifically from 120 to 180.

In another specific embodiment, polymer XXVII is a polymer of formula XXVII.2

(CH₃O)₃Si—(CH₂)₃—NH—C(═O)—O—[CH(CH₃)—CH₂—O—]ᵤ—C(═O)—NH—(CH₂)₃—Si(OCH₃)₃ (XXVII.2)

where u is from 1 to 500, preferably 10 to 400, more preferably 50 to 400, in particular from 100 to 350, specifically from 200 to 350, very specifically from 200 to 310.

Such STPs are known and sold, for example under the Geniosil® brands from Wacker (e.g. Geniosil® STP-E 10 or Geniosil® STP-E 35)

Silyl-modified polymers with laterally bound silyl groups are preferably also derived from polymers selected from the group consisting of polyethers, polyesters, polyamides, polyimines, polyurethanes, poly(meth)acrylates, polyvinylesters, polyolefins and mixed forms thereof, and in particular from polyethers, polyesters, polyamides, polyimines, polyurethanes, poly(meth)acrylates, polyvinylesters, polyolefins and mixed forms thereof as defined above in context with Po. The silyl groups are however not (exclusively) bound to the termini of the polymers, but mainly somewhere else on the polymer chain. The polymer is preferably derived from a polyether. The polyether is in particular a polyethylene glycol or polypropylene glycol, and is specifically polypropylene glycol.

In the silyl-modified polymers with laterally bound silyl groups the silyl group is preferably of the formula [(R′)ₐ(R″O)₃₋ₐSi—], where R′, R″ and a are as defined above. The silyl group can be directly bound to the polymer backbone or, more expediently, via a group Y (resulting in a group [(R′)ₐ(R″O)₃₋ₐSi—Y—]) or a group L¹-Y (resulting in a group [(R′)ₐ(R″O)₃₋ₐSi-L¹-Y—], where L¹ and Y are as defined above, where Y is additionally selected from —NH— and —NH—C(═O)—NH—.

Silyl-modified polymers with laterally bound silyl groups preferably contain in average 1 to 10, in particular 1 to 6, specifically 2 to 4 silyl groups per polymer molecule.

Preferably, the polymer composition B contains the at least one light stabilizer (a) and the at least one silyl-modified polymer (i) in a weight ratio of from 1:10 to 1:1000, more preferably of from 1:20 to 1:500, even more preferably of from 1:50 to 1:400, in particular from 1:50 to 1:300, specifically from 1:70 to 1:200.

In a preferred embodiment the polymer composition B contains following components in following ratios:
(i) at least one silyl-modified polymer: 10 to 99.91% by weight;
(a) at least one liquid light stabilizer selected from sterically hindered amines (HALS) in which the amino group carries a basicity-reducing substituent, the liquid light stabilizer having a molecular weight of at most 1500 g/mol: 0.05 to 10% by weight;
(b) at least one light stabilizer selected from sterically hindered amines (HALS) having a molecular weight of more than 1500 g/mol: 0.02 to 10% by weight;
(c) at least one liquid UV absorber: 0.02 to 10% by weight;
(d) at least one antioxidant: 0 to 15% by weight;
(e) at least one further additive: 0 to 80% by weight.

More preferably, the polymer composition B contains following components in following ratios:
(i) at least one silyl-modified polymer: 50 to 99.8% by weight;
(a) at least one liquid light stabilizer selected from sterically hindered amines (HALS) in which the amino group carries a basicity-reducing substituent, the liquid light stabilizer having a molecular weight of at most 1500 g/mol: 0.1 to 2% by weight;
(b) at least one light stabilizer selected from sterically hindered amines (HALS) having a molecular weight of more than 1500 g/mol: 0.05 to 1% by weight;
(c) at least one liquid UV absorber: 0.05 to 1% by weight;
(d) at least one antioxidant: 0 to 5% by weight;
(e) at least one further additive: 0 to 30% by weight.

In particular, the polymer composition B contains following components in following ratios:
(i) at least one silyl-modified polymer: 80 to 98% by weight;
(a) at least one liquid light stabilizer selected from sterically hindered amines (HALS) in which the amino group carries a basicity-reducing substituent, the liquid light stabilizer having a molecular weight of at most 1500 g/mol: 0.2 to 1% by weight;
(b) at least one light stabilizer selected from sterically hindered amines (HALS) having a molecular weight of more than 1500 g/mol: 0.1 to 0.5% by weight;
(c) at least one liquid UV absorber: 0.1 to 0.5% by weight;
(d) at least one antioxidant: 0 to 3% by weight;
(e) at least one further additive: 0 to 15% by weight.

The percentages by weight are based on the total weight of the polymer composition B. The weights of (i) and (a) to (e) add up to 100% by weight.

As already explained above, in a particular embodiment, the polymer composition B contains at least one component (e). Preferably, component (e) is selected from the above-described plasticizers (e.18), catalysts (e.16) and photolatent initiators (e.17) and in particular from the above-described plasticizers (e.18) and catalysts (e.16).

Preferably, the polymer composition B is liquid at 25° C. and 1013 mbar and contains at most 5% by weight, in particular at most 2% by weight, more particularly at most 1% by weight, based on the total weight of the composition, of solvents. In a particular embodiment, the polymer composition B does not contain any solvent. This allows applying the polymer composition in very convenient ways, for example even by spray application, without the necessity of heating and without the necessity to remove solvents. A further advantage is that the polymer composition, contrary to hot melt adhesive compositions, can be applied to thermally sensitive substrates. Moreover, the composition can be applied to substrates sensitive to solvents, especially organic solvents.

In analogy to what has been said above, “liquid at 25° C. and 1013 mbar” in the terms of the present invention means that the polymer composition B has a viscosity of at most 250 Pa·s at 25° C. and 1013 mbar, as measured with a CAP 2000+ Viscometer (Brookfield), cone 4, according to DIN EN ISO 3219, annex B at a shear rate of 100 s⁻¹. In particular, the polymer composition has a viscosity of at most 200 Pa·s at 25° C., e.g. from 0.1 to 200 Pa·s at 25° C., in particular a viscosity of at most 150 Pa·s at 25° C., e.g. from 0.5 to 150 Pa·s at 25° C., more particularly a viscosity of at most 100 Pas at 25° C., e.g. from 1 to 100 Pa·s at 25° C., even more particularly a viscosity of at most 50 Pa·s at 25° C., e.g. from 1 to 50 Pa·s at 25° C., specifically a viscosity of at most 40 Pa·s at 25° C., e.g. from 5 to 40 Pa·s at 25° C., and very specifically a viscosity of at most 30 Pa·s at 25° C., e.g. from 10 to 30 Pa·s at 25° C. The viscosities relate to values as obtained with the method described above.

“Solvent” is a liquid substance that dissolves a solute (a chemically different liquid, solid or gas), resulting in a solution. In terms of the present invention, the solvent is not restricted to a compound or medium which dissolves the solutes in the proper sense: This compound or medium may be more generally a dispersing medium, and thus the “solution” might be a suspension, emulsion or a solution in the proper sense (i.e. a homogeneous mixture composed of two or more substances, where the particles of the solute cannot be seen by naked eye and which does not scatter light). As used above, the term “solvent” does not include any of components (i) and (a) to (e), even if these are liquid and may principally act as a solvent for one or more of the other components. As used above, this term includes only liquid substances which are different from components (i) and (a) to (e) and are able to dissolve a solute.

The polymer composition B is prepared by principally known methods, such as intimately mixing the components, either simultaneously or consecutively, in suitable dispersing units, such as mixers, in particular high-speed mixers, planetary mixers, internal mixers, compounders, twin-screw-extruders etc.

The invention further relates to the use of the stabilizer composition A of the invention for stabilizing a silyl-modified polymer or a sealant, adhesive, gasket, knifing filler or coating composition, especially a sealant composition, adhesive composition, gasket composition, knifing filler composition or coating composition containing a silyl-modified polymer, or the finished products obtained from said compositions, against degradation by heat, light and/or oxygen.

The invention also relates to the use of the polymer composition B of the invention as or in a sealant composition, adhesive composition, gasket composition, knifing filler composition or coating composition.

The invention also relates to a sealant composition or an adhesive composition, or a gasket composition, or a knifing filler composition or a coating composition comprising the polymer composition B of the invention.

Moreover, the invention relates to a method for stabilizing a silyl-modified polymer or a sealant, adhesive, gasket, knifing filler or coating composition, especially a sealant, adhesive, gasket, knifing filler or coating composition containing a silyl-modified polymer, or the finished products obtained from said compositions, against degradation by heat, light and/or oxygen, which method comprises adding to a silyl-modified polymer or a sealant, adhesive, gasket, knifing filler or coating composition, especially a sealant, adhesive, gasket, knifing filler or coating composition containing a silyl-modified polymer, the stabilizer composition A of the invention.

The invention also relates to the use of a stabilizer composition A in a sealant or adhesive composition for improving at least one optical property in the finished sealant or adhesive, where the improved optical property is selected from increased clarity and/or reduced haze.

Adhesive and sealant are partly overlapping terms.

Sealants are substances used to block the passage of fluids through the surface or joints or openings in materials. They have to show adhesion to the substrates which they are to seal, but more importantly they have to have a strong cohesion. Cohesion is the property of a substance to stick together, i.e. its inner force.

Adhesives are substances that bind together substrates and resist their separation. Adhesive interactions are here of more importance than cohesive forces, although without cohesion an adhesive cannot work, either.

Some applications for the sealant and adhesive compositions of the present invention are for example deck bonding and sealing, port holes sealing, cables sealing, glazing, windows sealing, bathroom water-barrier sealing and adhesives or sealing of flooring, especially of parquet.

The stabilizer composition of the invention effectively stabilizes curable compositions, and especially provides a good long-term temperature and/or UV and/or oxidation stability after curing, and at the same time avoids negative interactions of the components. The stabilizer composition is liquid without having to resort to additional solvents, is stable without the presence of dispersants, surfactants, emulsifiers and the like, is combinable with phenolic antioxidants without causing any “pinking” of the substrate equipped therewith over time, and/or is substantially clear and/or shows substantially no haze (turbidity).

The invention is now illustrated by the following examples.

### EXAMPLES

Materials used:
Geniosil® STP-E 35: a trimethoxysilylpropylcarbamate-terminated polyether polymer from Wacker; dynamic viscosity at 25° C.: ca. 30000 mPa·s
Tinuvin® 249 a HALS compound (a); compound of formula (I.a); dynamic viscosity at 25° C.: ca. 450 mPa·s; from BASF SE
Tinuvin® 292 a HALS compound in which the nitrogen atom of the piperidine ring carries a methyl group; not according to light stabilizers (a) or (b) of the invention; dynamic viscosity at 25° C.: ca. 450 mPa·s; molecular weight: 508 g/mol; from BASF SE
Joncryl® 1230 polybutylacrylate; plasticizer; M ca. 19000; dynamic viscosity at 25° C.: 2700 mPa·s; from BASF SE
Tinuvin® 622 a high molecular weight HALS compound (b); compound of formula (III), wherein R^{2a}, R^{2b}, R^{3a} and R^{3b} are methyl, E is —CH₂CH₂—O—C(═O)—CH₂CH₂—, R¹⁶ is hydrogen, R¹⁷ is methoxy, and k is from 10 to 15; from BASF SE
Uvinul® 3039 UV absorber; compound of formula (IX) wherein R^{A} is 2-ethylhexyl; from BASF SE
DBTL dibutyltindilaurate; catalyst

Compositions

The compositions were prepared by intimately mixing the components with a SpeedMixer DAC 400 FVZ from Hauschild Engineering, Germany, in the relative amounts given in the following tables. The amounts are given in parts by weight.

Test Methods

Color was evaluated by Gardner color number index according to ASTM D-6166. Higher numbers mean higher color, i.e. higher oxidation.

Turbidity was recorded as FNU according to DIN EN ISO 7027. Higher Turbidity means more insoluble particles.

The viscosities were measured using a CAP 2000+ Viscometer (Brookfield) according DIN EN ISO 3219, annex B at a shear rate of 100 s⁻¹.

Shore A Hardness was determined according to DIN 53505 using a shore scale A durometer. Lower hardness means higher deterioration of the sealant compound.

Tests

A stabilizer composition containing the low molecular weight HALS (a) Tinuvin® 249, the high molecular weight HALS (b) Tinuvin® 622 and the UV absorber (c) Uvinul® 3039 in a weight ratio of 2:1:1 [(a):(b):(c)] were prepared and the Gardner color and turbidity were tested.

For comparison, a stabilizer composition containing the low molecular weight HALS Tinuvin® 292 (comp-a), the high molecular weight HALS (b) Tinuvin® 622 and the UV absorber (c) Uvinul® 3039 in a weight ratio of 2:1:1 [(comp-a):(b):(c)] were prepared and the Gardner color and turbidity were tested.

The results are compiled in Table 1 below.

TABLE 1

| | Low MW HALS | High MW | UV absorber | | |
|---|---|---|---|---|---|
| Exp | (a)/(comp-a) | HALS (b) | (c) | Gardner | |
| No. | Tinuvin ® | Tinuvin ® | Tinuvin ® | Color | Turbidity |
| 1 | 249 | 622 | 3039 | 2 | 50 |
| Comp-1 | 292 | 622 | 3039 | 6 | 100 |

Polymer compositions were prepared using the above stabilizer compositions. The components of the polymer compositions and respective amounts are listed in Table 2.

TABLE 2

| Components | Parts by weight |
|---|---|
| Geniosil STP E-35 | 90 |
| Joncryl ADP 1230 | 10 |
| DBTL | 0.5 |
| Stabilizer composition | 1 |
| | Σ 101.5 |

Polymer composition P1 contains the stabilizer composition 1 as defined above. Polymer composition Comp-P1 contains the stabilizer composition Comp-1 as defined above.

The sealant hardness of the polymer compositions was determined. The results are compiled in Table 3.

TABLE 3

| Exp No. | Stabilizer composition | Shore A Hardness |
|---|---|---|
| P1 | 1 | 50 |
| Comp-P1 | Comp-1 | 44 |

As the results show, the stabilizer composition 1 according to the invention has a distinctly lower Gardner color and turbidity than the comparative composition containing a HALS compound with an electron-donating group on the piperidine nitrogen atoms. The sealant composition prepared with the stabilizer composition 1 according to the invention has a distinctly higher shore A hardness than the sealant composition prepared with the comparative stabilizer composition, which means that it is less prone to deterioration.

1.-15. (canceled)

16. A liquid stabilizer composition, measured according to DIN EN ISO 3219, comprising:
(a) at least one liquid light stabilizer, measured according to DIN EN ISO 3219, selected from sterically hindered amines (HALS) in which the amino group carries a basicity-reducing substituent, the liquid light stabilizer having a molecular weight of at most 1500 g/mol and have a pK_{b} value of from 7 to 10;
(b) at least one light stabilizer, measured according to DIN EN ISO 3219, selected from sterically hindered amines (HALS) having a molecular weight of more than 1500 g/mol and have a pK_{b} value of from 7 to 10;
(c) at least one liquid UV absorber, measured according to DIN EN ISO 3219;
(d) optionally at least one antioxidant; and
(e) optionally at least one further additive;
wherein the basicity-reducing substituent is selected from the group consisting alkoxy, alkenyloxy, alkynyloxy, cycloalkoxy, phenyloxy or benzyloxy groups and carbonyl or thiocarbonyl groups either bound directly or flexibly in γ- or δ-position to the nitrogen ring atom.

17. The stabilizer composition according to claim 16, wherein the liquid light stabilizer of component (a) has a molecular weight of at most 1000 g/mol and the light stabilizer of component (b) has a molecular weight of at least 1700 g/mol.

18. The stabilizer composition according to claim 17, wherein the liquid light stabilizer of component (a) has a molecular weight from 150 to 800 g/mol, and the light stabilizer of component (b) has a molecular weight from 2500 to 20,000 g/mol.

19. The stabilizer composition according to claim 16, wherein the liquid light stabilizer of component (a) is selected from the group consisting of
compounds of the formula (I) 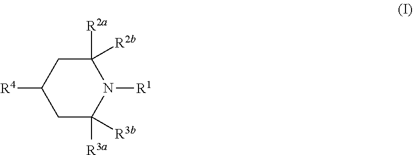
where
R¹ is a group -A-C(═X)—R⁵ or a group —OR⁶;
R^{2a}, R^{2b}, R^{3a} and R^{3b}, independently of each other, are C₁-C₃-alkyl;
R⁴ is selected from the group consisting of hydrogen, C₁-C₁₂-alkyl which may carry one or more substituents R⁷; —OR⁸, —S(O)ₘR⁹, —NR^{10a}R^{10b}, —C(═O)R¹¹ and —C(═S)R¹¹;
R⁵ is selected from the group consisting of C₁-C₁₂-alkyl which may carry one or more substituents R⁷;
—OR⁸, and —NR^{10a}R^{10b};
R⁶ is selected from the group consisting of C₁-C₁₂-alkyl which may carry one or more substituents R⁷; and —C(═O)—C₁-C₈-alkyl, where the alkyl moiety may carry one or more substituents R⁷;
each R⁷ is independently selected from the group consisting of —OR⁸, —OSO₂R⁸, —S(O)ₘR⁹, —N(R^{10a})R^{10b}, —C(═O)N(R^{10a})^{R10}b, —C(═S)N(R^{10a})R^{10b}, —C(═O)OR⁸, —CH═NOR⁸, —Si(R¹²)₃, C₃-C₆-cycloalkyl, optionally substituted with one or more substituents R¹³, phenyl, optionally substituted with 1, 2, 3, 4 or 5 substituents R¹³, and a 3-, 4-, 5-, 6- or 7-membered saturated, partially unsaturated or maximally unsaturated heterocyclic ring comprising 1, 2 or 3 heteroatoms or heteroatom groups selected from the group consisting of N, O, S, NO, SO and SO₂, as ring members, where the heterocyclic ring is optionally substituted with one or more substituents R¹³;
each R⁸ is independently selected from the group consisting of hydrogen, C₁-C₁₂-alkyl which may carry one or more substituents R¹⁴; and —C(═O)—C₁-C₁₂-alkyl, where the alkyl moiety may carry one or more substituents R¹⁴;
each R⁹ is independently selected from the group consisting of hydrogen, C₁-C₁₂-alkyl which may carry one or more substituents R¹⁴; and C₁-C₁₂-alkoxy;
R^{10a} and R^{10b}, independently of each other and independently of each occurrence, are selected from the group consisting of hydrogen, C₁-C₁₂-alkyl which may carry one or more substituents R¹⁴; and C₁-C₁₂-alkoxy;
each R¹¹ is independently selected from the group consisting of hydrogen, C₁-C₁₂-alkyl which may carry one or more substituents R¹⁴; and C₁-C₁₂-alkoxy;
each R¹² is independently selected from the group consisting of C₁-C₁₂-alkyl which may carry one or more substituents R^{M}; and C₁-C₁₂-alkoxy;
each R¹³ is independently selected from the group consisting of hydroxyl, cyano, C₁-C₄-alkyl and C₁-C₄-alkoxy, or two R¹³ bound on the same carbon atom of a cycloalkyl ring or a heterocyclic ring may form together a group ═O;
each R¹⁴ is independently selected from the group consisting of —Si(R¹⁵)₃, hydroxyl, cyano, C₁-C₁₂-alkoxy, amino, C₁-C₄-alkylamino, aminocarbonyl, C₁-C₄-alkylaminocarbonyl, di(C₁-C₄-alkyl)-aminocarbonyl, C₁-C₄-alkylcarbonyl, C₁-C₄-alkoxycarbonyl, C₃-C₆-cycloalkyl, optionally substituted with 1, 2, 3, 4 or 5 substituents R¹³, phenyl, optionally substituted with 1, 2, 3, 4 or 5 substituents R¹³, and a 3-, 4-, 5-, 6- or 7-membered saturated, partially unsaturated or maximally unsaturated heterocyclic ring comprising 1, 2 or 3 heteroatoms or heteroatom groups selected from the group consisting of N, O, S, NO, SO and SO₂, as ring members, where the heterocyclic ring is optionally substituted with one or more substituents R¹³;
each R¹⁵ is independently selected from the group consisting of C₁-C₁₂-alkyl and C₁-C₁₂-alkoxy;
A is —(CH₂)ₙ— or —(CH₂)ₚ—O—, where O is bound to C(═X);
X is O or S;
m is 0, 1 or 2;
n is 3 or 4; and
p is 2 or 3;
compounds of formula (II) 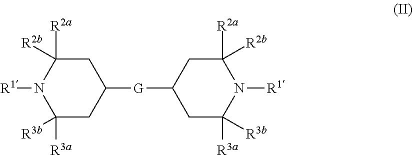
where
each R¹′ has independently one of the meanings given above for R¹;
R^{2a}, R^{2b}, R^{3a} and R^{3b}, independently of each other, are as defined above; and
G is selected from the group consisting of C₁-C₁₀-alkylene, —O—C₂-C₁₀-alkylene-O—, —C(═O)—C₁-C₁₀-alkylene-C(═O)—, and —O—C(═O)—C₁-C₁₀-alkylene-C(═O)—O—;
and
mixtures thereof.

20. The stabilizer composition according to claim 16, wherein the liquid light stabilizer of component (a) is selected from the group consisting of the compound of formula (I.a), the compound of formula (II.a) and mixtures thereof

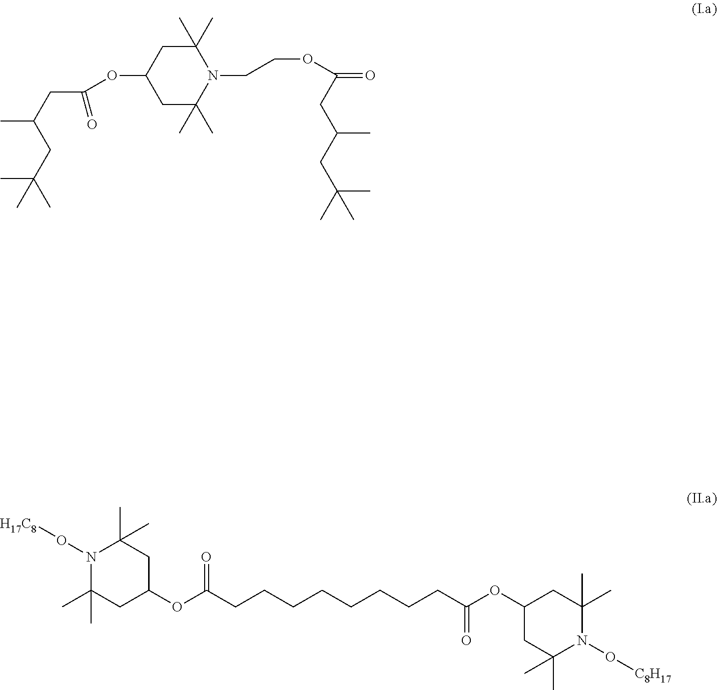

21. The stabilizer composition according to claim 16, wherein the light stabilizer of component (b) is selected from
compounds of formula (III) 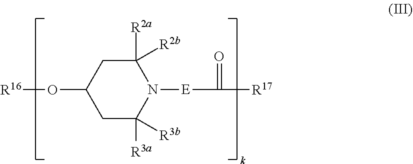
where
R^{2a}, R^{2b}, R^{3a} and R^{3b}, independently of each other, are C₁-C₃-alkyl;
E is —(CH2)n-, —(CH2)p-O—, where O is bound to C(═O), —(CH2)n-C(═O)-E1-, or —(CH2)p-O—C(═O)-E¹-, where
n is 3 or 4;
p is 2 or 3; and
E¹ is linear or branched C₁-C₁₀-alkylene;
R¹⁶ is hydrogen or C₁-C₄-alkyl;
R¹⁷ is hydrogen, C₁-C₄-alkyl or C₁-C₄-alkoxy; and
k is 3 to 50;
compounds of formula (IV) 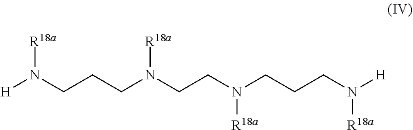
where R^{18a} is: 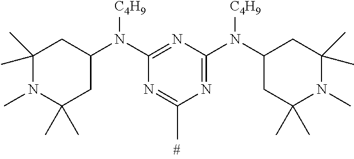
(R^{18a})
where C₄H₉ is n-butyl and # denotes the attachment point to the nitrogen atom to which R^{18a} is bound,
compounds of formula (V) 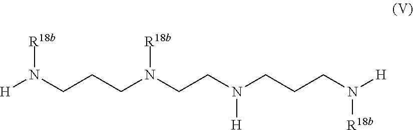
where R^{18b} is: 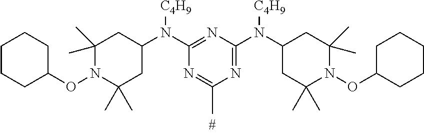
(R^{18b})
where C₄H₉ is n-butyl and # denotes the attachment point to the nitrogen atom to which R^{18b} is bound,
compounds of formula (VI) 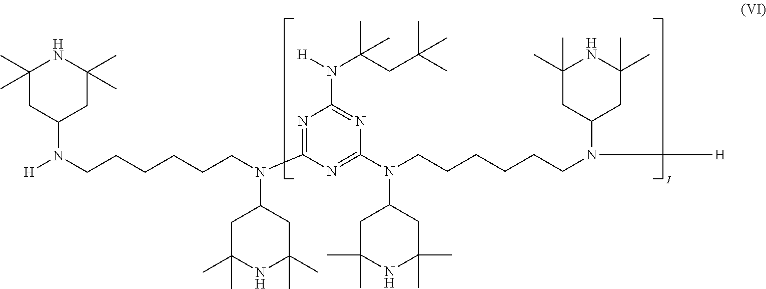
where
l is from 2 to 5;
compounds of formula (VII) 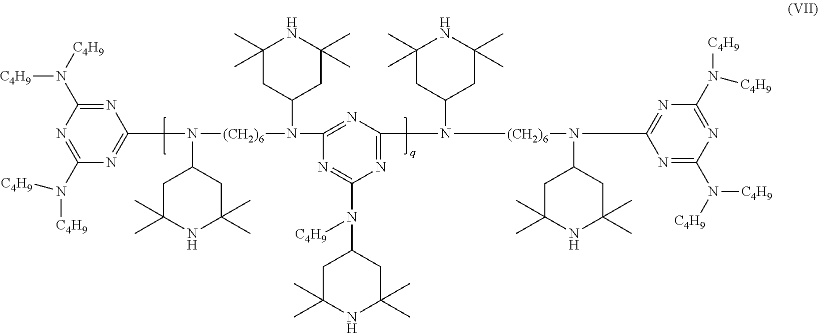
where
q is from 2 to 5; and
C₄H₉ is n-butyl;
compounds of formula (VIII) 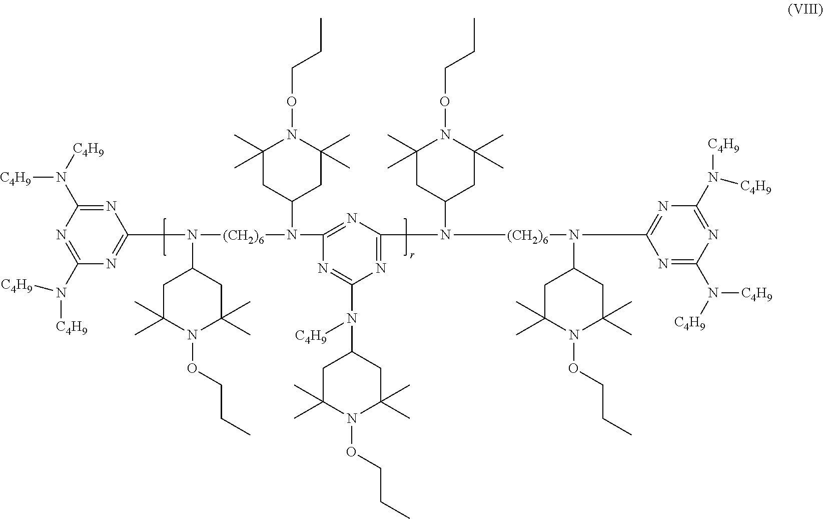
where
r is from 3 to 5; and
C₄H₉ is n-butyl;
and
mixtures thereof.

22. The stabilizer composition according to claim 16, where the light stabilizer of component (b) is selected from sterically hindered amines (HALS) in which the amino group carries a basicity-reducing substituent.

23. The stabilizer composition according to claim 22, wherein the light stabilizer of component (b) is selected from the group consisting of compounds of formula (III) in which R^{2a}, R^{2b}, R^{3a} and R^{3b} are methyl, E is —CH₂CH₂—O—C(═O)—CH₂CH₂—, R¹⁶ is hydrogen, R¹⁷ is methoxy, and k is from 10 to 15.

24. The stabilizer composition according to claim 16, wherein the UV absorber of component (c) is selected from the group consisting of cyanoacrylates, benzotriazoles, hydroxyphenyl triazines and formamidines.

25. The stabilizer composition according to claim 24, wherein the UV absorber of component (c) is selected from the group consisting of
cyanoacrylates of the formula (IX) 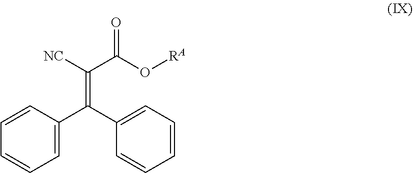
where
R^{A} is C₁-C₁₀-alkyl;
benzotriazoles of the formula (X) 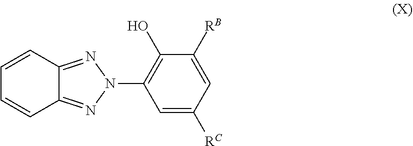
wherein
R^{B} is C₁-C₁₄-alkyl;
R^{C} is selected from the group consisting of C₁-C₄-alkyl and —CH₂CH₂—C(═O)—O—R¹⁹; and
R¹⁹ is C₁-C₁₀-alkyl;
benzotriazoles of the formula (XI)
R^{D}—(OCH₂CH₂)ₛ—R^{E} (XI)
where
R^{D} is a group of the formula (XII) 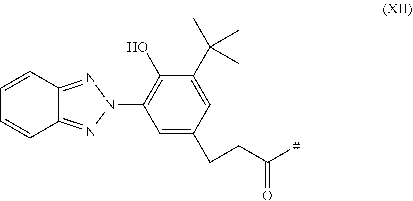
where # denotes the attachment point to the remainder of the molecule;
R^{E} is R^{D} or OH; and
s is 6 to 7;
hydroxyphenyltriazines of the formula (XIII) 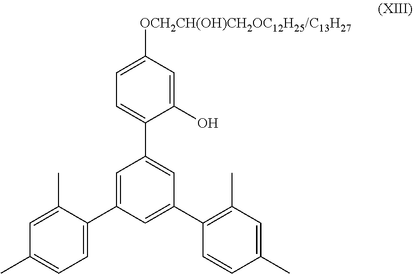
hydroxyphenyltriazines of the formula (XIV) 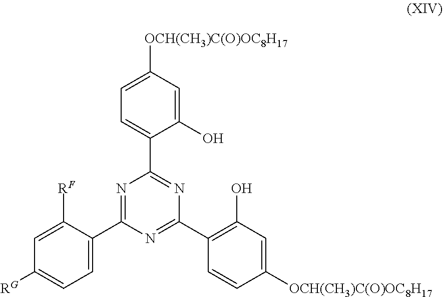
where
R^{F} and R^{G} are both OH, or are both OCH(CH₃)C(O)OC₈H₁₇ or R^{F} is OH and R^{G} is OCH(CH₃)C(O)OC₈H₁₇;
the formamidine of the formula (XV) 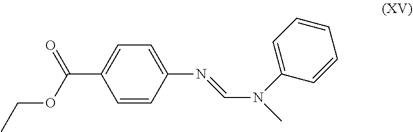 [SMILES: CCOC(=O)c1ccc(/N=C/N(C)c2ccccc2)cc1]
and
mixtures thereof;
in particular from the group consisting of
the cyanoacrylate of the formula (IX), wherein R^{A} is 2-ethylhexyl;
the benzotriazole of the formula (XI), wherein R^{E} is R^{D};
the benzotriazole of the formula (XI), wherein R^{E} is OH; and
mixtures of the benzotriazole of the formula (XI), wherein R^{E} is R^{D} and the benzotriazole of the formula (XI), wherein R^{E} is OH;
and is specifically the cyanoacrylate of the formula (IX), wherein R^{A} is 2-ethylhexyl.

26. The stabilizer composition according to claim 25, wherein the UV absorber of component (c) is selected from the group consisting of
the cyanoacrylate of the formula (IX), wherein R^{A} is 2-ethylhexyl;
the benzotriazole of the formula (XI), wherein R^{E} is R^{D};
the benzotriazole of the formula (XI), wherein R^{E} is OH; and
mixtures of the benzotriazole of the formula (XI), wherein R^{E} is R^{D} and the benzotriazole of the formula (XI), wherein R^{E} is OH.

27. The stabilizer composition according to claim 16, wherein the weight ratio of component (a) and component (b) is of from 10:1 to 1:10; and the weight ratio of component (a) and component (c) is of from 10:1 to 1:10.

28. The stabilizer composition according to claim 27, wherein the weight ratio of component (a) and component (b) is from 2.5:1 to 1.5:1 and the weight ratio of component (a) and component (c) is from 2.5:1 to 1.5:1.

29. The stabilizer composition according to claim 16, wherein component d) is a phenolic antioxidant selected from the group consisting of
compounds of the formula (XVI)
R²⁰—O-A¹-O—R²¹ (XVI)
compounds of the formula (XVII)
R²⁰—[O—(CH₂)₂]ₜ—OR²⁰ (XVI)
compounds of the formula (XVIII)
R²⁰—N(H)-A²-N(H)—R²⁰ (XVIII)
compounds of the formula (XIX)
C(CH₂—O—R²⁰)₄ (XIX)
where in compounds (XVI) to (XIX)
R²⁰ is a group of the formula (XX) 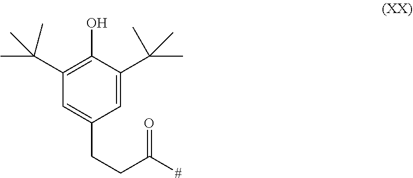
where # denotes the attachment point to the remainder of the molecule;
R²¹ is R²⁰ or C₁-C₁₀-alkyl;
A¹ is (CH₂)ᵤ or —(CH₂)₂—S—(CH₂)₂—;
A² is a covalent bond or (CH₂)ᵤ;
t is from 1 to 4; and
u is from 2 to 8;
compounds of the formula (XXI) 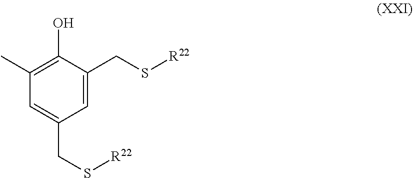
where either both R²² are C₈H₁₇ or both are C₁₂H₂₅;
the compound of the formula (XXII) 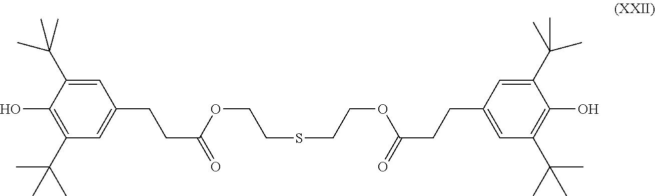 [SMILES: CC(C)(C)c1cc(CCC(=O)OCCSCCOC(=O)CCc2cc(C(C)(C)C)c(O)c(C(C)(C)C)c2)cc(C(C)(C)C)c1O]
the compound of the formula (XXIII) 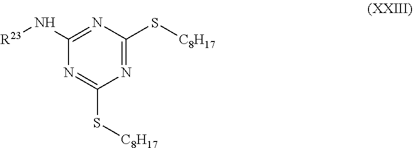
the compound of the formula (XXIV) 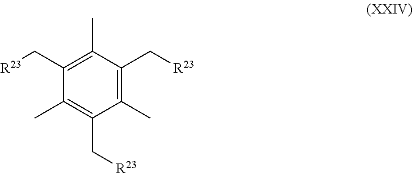
the compound of the formula (XXV) 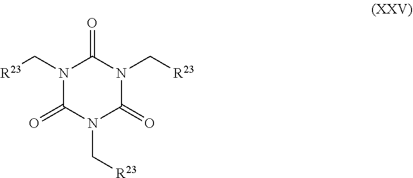
where in compounds (XXIII) to (XXV) R²³ is a group of the formula (XXVI) 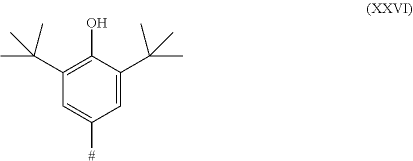
where # denotes the attachment point to the remainder of the molecule; and
mixtures thereof.

30. The stabilizer composition according to claim 16, comprising
(a) 2 to 80% by weight, based on the total weight of the composition, of component (a);
(b) 1 to 50% by weight, based on the total weight of the composition, of component (b);
(c) 1 to 50% by weight, based on the total weight of the composition, of component (c);
(d) 0 to 90% by weight, based on the total weight of the composition, of component (d); and
(e) 0 to 96% by weight, based on the total weight of the composition, of component (e).

31. A polymer composition, comprising
(i) at least one silyl-modified polymer, in particular at least one silyl-terminated polymer; and
(ii) a stabilizer composition as defined in claim 16.

32. The polymer composition according claim 26, wherein the silyl-terminated polymer (i) is a polymer of formula XXVII
[(R′)ₐ(R″O)₃₋ₐSi-L¹-Y]_{b}—Po (XXVII)
where
Po is the di-, tri- or tetravalent radical of a base polymer;
each Y is independently selected from the group consisting of a bond, —NH—C(═O)—O—, —O—C(═O)—NH—, —C(═O)—NH-L²-NH—C(═O)—NH—, —NH—C(═O)—NH-L²-NH—C(═O)—, —O—C(═O)—, —C(═O)—O—, —NH—C(═O)—S—, —S—C(═O)—NH— and —O—;
R′ and R″, independently of each other and independently of each occurrence, are selected from C₁-C₆-alkyl;
L¹ is C₁-C₃-alkylene;
L² is a divalent aliphatic, cycloaliphatic or aromatic radical;
each a is independently 0 or 1; and
b is 2, 3 or 4.

33. The polymer composition according to claim 27, where Po is the di-, tri- or tetravalent radical of a polymer selected from the group consisting of polyethers, polyesters, polyamides, polyimines, polyurethanes, poly(meth)acrylates, polyvinylesters, polyolefins and mixed forms thereof.

34. The polymer composition according to claim 27, where
Y is —NH—C(═O)—O— (where NH is bound to L¹);
R′ and R″, independently of each other and independently of each occurrence, are selected from the group consisting of methyl and ethyl; and
each L¹ is independently —CH₂— or C₃-alkylene.

35. A method of improving an optical property of a sealant or adhesive composition comprising combining the stabilizer composition as defined in claim 16 with the sealant or adhesive composition, where the improved optical property is selected from increased clarity and/or reduced haze, and/or for improving the stability of the sealant or adhesive composition or of the finished sealant or adhesive against degradation by heat, light and/or oxygen.
